(19) United States
(12) Patent Application Publication
(10) Pub. No.: US 2026/0328155 A1
(43) Pub. Date: Oct. 22, 2026

(54) Internal Combustion Engine Control Device and State Amount Estimation Method

(71) Applicant: Hitachi Astemo, Ltd., Hitachinaka-shi, Ibaraki (JP)

(72) Inventors: Akihiro KOMORI, Hitachinaka-shi, Ibaraki (JP); Kunihiko SUZUKI, Hitachinaka-shi, Ibaraki (JP)

(21) Appl. No.: 19/104,743

(22) PCT Filed: Oct. 20, 2022
(86) PCT No.: PCT/JP2022/039104

§ 371 Date: Feb. 19, 2025

(51) Int. Cl. F02D 41/24; F02D 41/14

(52) U.S. Cl. CPC F02D 41/2454; F02D 41/1445; F02D 41/1446; F02D 41/1453; F02D 41/1454; F02D 41/1462; F02D 41/1463; F02D 41/1495; F02D 41/1405; F02D 2041/1417; F02D 2041/1433; F02D 2200/0804

(57) ABSTRACT

An internal combustion engine control device includes an exhaust gas flow rate calculation unit, an exhaust gas temperature detection unit, a catalyst upstream state amount estimation unit that receives a catalyst upstream air-fuel ratio, an exhaust gas flow rate, and exhaust gas temperature as inputs and estimates a catalyst upstream NOx emission amount, a catalyst upstream HC emission amount, and a catalyst upstream CO emission amount as catalyst upstream state amounts, a catalyst downstream state amount estimation unit that receives a catalyst upstream air-fuel ratio, an exhaust gas flow rate, exhaust gas temperature, and a catalyst upstream state amount as inputs and estimates catalyst temperature, oxygen storage capacity, a catalyst downstream air-fuel ratio, a catalyst downstream NOx emission amount, a catalyst downstream HC emission amount, and a catalyst downstream CO emission amount of a three-way catalyst as catalyst downstream state amounts, and a correction unit that corrects a catalyst downstream NOx emission amount, a catalyst downstream HC emission amount, and a catalyst downstream CO emission amount using an NOx sensor value detected by a downstream NOx sensor.

### TECHNICAL FIELD

The present invention relates to an internal combustion engine control device and a state amount estimation method.

### BACKGROUND ART

Conventionally, there is known a control technique in which a three-way catalyst is provided in an exhaust pipe of an internal combustion engine, an oxygen storage state in the three-way catalyst is captured by an exhaust gas sensor assembled before and after the three-way catalyst, and an air-fuel ratio (or an equivalence ratio) is corrected according to a detection result of the oxygen storage state. In this control technique, rich correction of an air-fuel ratio is determined based on an oxygen storage state captured by time integration of the product of a difference value between a stoichiometric air-fuel ratio and an air-fuel ratio of exhaust gas and an amount of air sucked into an internal combustion engine. Furthermore, an exhaust gas sensor assembled downstream of the three-way catalyst detects a level of oxygen released downstream of the three-way catalyst, so that feedback correction of air-fuel ratio control is performed. In description below, a three-way catalyst is also abbreviated as a “catalyst”.

### CITATION LIST

### Patent Literature

PTL 1: JP 2021-71104 A
PTL 2: JP 2022-81026 A

### SUMMARY OF INVENTION

### Technical Problem

In recent years, exhaust gas regulations of automobiles have become stricter year by year, and it is required to realize On Board Monitoring (hereinafter abbreviated as “OBM”) for monitoring a plurality of regulated exhaust gas components (emissions) corresponding to regulations on harmful substances emitted from an internal combustion engine in real time in an ECU. In OBM, in order to detect emission deterioration due to degeneration of a catalyst in an exhaust pipe that gradually progresses in a use process of an automobile, it is required to measure emission downstream of a catalyst in real time and with high accuracy and present (indicate) the measured information to an automobile user. Presentation (indication) of measured information to an automobile user is assumed to be, for example, turning on a warning lamp.

Among the above-described emission, real-time measurement of NOx, which is one regulated exhaust gas component, can be realized by a nitrogen oxide (NOx) sensor for automobiles. However, real-time measurement of hydrocarbon (HC) and carbon monoxide (CO), which are other regulated exhaust gas components, conventionally requires a very expensive and large exhaust analysis device as used in typical research and development applications. However, it is practically impossible to mount (mount on a vehicle) such an expensive and large exhaust analysis device on an automobile used on a general public road (on a road). In other words, it has been difficult in the conventional technique to measure HC and CO directly and in real time in an automobile in a general use process.

For example, PTL 1 described above discloses a technique for estimating each purification rate of HC, CO, and NOx by a catalyst state estimation model using information on exhaust from an exhaust gas sensor measurement value on the upstream side of a catalyst as a model input. However, PTL 1 does not disclose a configuration in which NOx, HC, and CO emission amounts downstream of a catalyst are measured or estimated in real time and the NOx, HC, and CO emission amounts are indicated.

Further, PTL 2 discloses a technique of estimating a variation amount and a catalyst state of an exhaust gas sensor provided upstream or downstream of a catalyst by a state space model, and correcting an exhaust gas sensor output value based on the estimated variation amount, or performing deterioration diagnosis of the exhaust gas sensor based on the estimated variation amount. However, as can be easily understood by those skilled in the art, PTL 2 merely describes a technique for individually performing correction or diagnosis of various exhaust gas sensor output values actually provided upstream or downstream of a catalyst. Therefore, as described above, PTL 2 does not disclose a configuration in which HC and CO emission amounts downstream of a catalyst are estimated without providing HC and CO sensors that are too expensive and large to be mounted on a vehicle, and an estimation result is indicated to an automobile user. In general, PTLs 1 and 2 do not disclose a configuration capable of highly accurately performing what is called OBM that measures, in real time, HC, CO, and NOx emission amounts downstream of a catalyst, the HC, CO, and NOx being a plurality of regulated exhaust gas components, and indicates the emission amounts.

The present invention has been made in view of such a situation, and an object of the present invention is to indicate HC, CO, and NOx emission amounts downstream of a catalyst in real time.

### Solution to Problem

An internal combustion engine control device according to the present invention controls an internal combustion engine including an upstream air-fuel ratio sensor that is provided in an exhaust pipe, arranged upstream of a three-way catalyst having oxygen storage capacity, and detects a catalyst upstream air-fuel ratio of exhaust gas, and a downstream NOx sensor that is arranged downstream of the three-way catalyst and detects NOx downstream of the three-way catalyst. This internal combustion engine control device includes an exhaust gas flow rate calculation unit that calculates an exhaust gas flow rate of exhaust gas, a catalyst upstream state amount estimation unit that receives a catalyst upstream air-fuel ratio, an exhaust gas flow rate, and exhaust gas temperature detected by an exhaust gas temperature sensor as inputs and estimates a catalyst upstream NOx emission amount, a catalyst upstream HC emission amount, and a catalyst upstream CO emission amount as catalyst upstream state amounts, a catalyst downstream state amount estimation unit that receives a catalyst upstream air-fuel ratio, an exhaust gas flow rate, exhaust gas temperature, and a catalyst upstream state amount as inputs and estimates catalyst temperature, oxygen storage capacity, a catalyst downstream air-fuel ratio, a catalyst downstream NOx emission amount, a catalyst downstream HC emission amount, and a catalyst downstream CO emission amount of a three-way catalyst as catalyst downstream state amounts, and a correction unit that corrects a catalyst downstream NOx emission amount, a catalyst downstream HC emission amount, and a catalyst downstream CO emission amount using an NOx sensor value detected by a downstream NOx sensor.

### Advantageous Effects of Invention

According to the present invention, since a catalyst downstream NOx emission amount, a catalyst downstream HC emission amount, and a catalyst downstream CO emission amount are estimated and corrected, corrected catalyst downstream NOx emission amount, catalyst downstream HC emission amount, and catalyst downstream CO emission amount can be indicated in real time without provision of HC and CO sensors.

### BRIEF DESCRIPTION OF DRAWINGS

FIG. 1 is an overall schematic configuration diagram of an internal combustion engine control system according to a first embodiment of the present invention.

FIG. 2 is a block diagram illustrating a hardware configuration example of an ECU according to the first embodiment of the present invention.

FIG. 3A is a schematic diagram illustrating a configuration example of an aftertreatment system according to the first embodiment of the present invention.

FIG. 3B is a diagram for explaining a relationship between an equivalence ratio of exhaust gas and output of an air-fuel ratio sensor according to the first embodiment of the present invention.

FIG. 3C is a diagram for explaining a relationship between an equivalence ratio of exhaust gas and output of a rear oxygen sensor according to the first embodiment of the present invention.

FIG. 4A is a diagram for explaining a tendency with respect to an equivalence ratio of H₂O (water), CO (carbon monoxide), CO₂ (carbon dioxide), H₂ (hydrogen), and O₂ (oxygen) according to the first embodiment of the present invention.

FIG. 4B is a diagram for explaining a tendency with respect to an equivalence ratio of HC (hydrocarbon) and NOx (nitrogen oxide) according to the first embodiment of the present invention.

FIG. 5 is a diagram for explaining main reaction processes of a three-way catalyst (ceria-based) used in the aftertreatment system according to the first embodiment of the present invention.

FIG. 6 is a diagram for explaining a tendency of a purification rate of a three-way catalyst with respect to an exhaust gas equivalence ratio at a catalyst activation temperature or higher according to the first embodiment of the present invention.

FIG. 7 is a diagram for explaining a catalyst upstream equivalence ratio, a catalyst downstream equivalence ratio, and output behavior of the rear oxygen sensor 22 according to the first embodiment of the present invention.

FIG. 8 is a diagram for explaining hysteresis of an output characteristic of the rear oxygen sensor according to the first embodiment of the present invention.

FIG. 9 is a diagram for explaining temporal changes of output of the rear oxygen sensor according to the first embodiment of the present invention and an NOx concentration and a HC concentration downstream of a catalyst.

FIG. 10 is a diagram for explaining a relationship between degree of catalyst deterioration and oxygen storage capacity of a three-way catalyst according to the first embodiment of the present invention.

FIG. 11 is a diagram for explaining a relationship between an oxygen storage ratio of a three-way catalyst and an NOx purification rate of the three-way catalyst according to the first embodiment of the present invention.

FIG. 12 is a diagram for explaining a comparison result of a catalyst upstream equivalence ratio, a catalyst downstream equivalence ratio, an oxygen storage ratio, and output behavior of the rear oxygen sensor in a case where a deteriorated catalyst and a new catalyst according to the first embodiment of the present invention are used.

FIG. 13 is a block diagram illustrating an internal configuration example of the ECU according to the first embodiment of the present invention.

FIG. 14 is a flowchart illustrating an example of processing of the ECU according to the first embodiment of the present invention.

FIG. 15 is a flowchart illustrating an example of a Kalman filter algorithm according to the first embodiment of the present invention.

FIG. 16A is a diagram for explaining a first machine learning model constituting a first state space model and a second machine learning model constituting a second state space model according to the first embodiment of the present invention.

FIG. 16B is a diagram illustrating an example of a neural network model according to the first embodiment of the present invention.

FIG. 17 is a block diagram of the first and second machine learning models for explaining a machine learning step according to the first embodiment of the present invention.

FIG. 18 is a flowchart of a first learning step and a second learning step according to the first embodiment of the present invention.

FIG. 19 is a block diagram illustrating an internal configuration example of the ECU according to a second embodiment of the present invention.

FIG. 20 is a flowchart illustrating an example of processing of the ECU according to the second embodiment of the present invention.

### DESCRIPTION OF EMBODIMENTS

Hereinafter, an embodiment for performing the present invention will be described with reference to the accompanying drawings. In the present description and the drawings, constituent elements having substantially the same function or configuration are denoted by the same reference numerals, and redundant description is omitted.

### First Embodiment

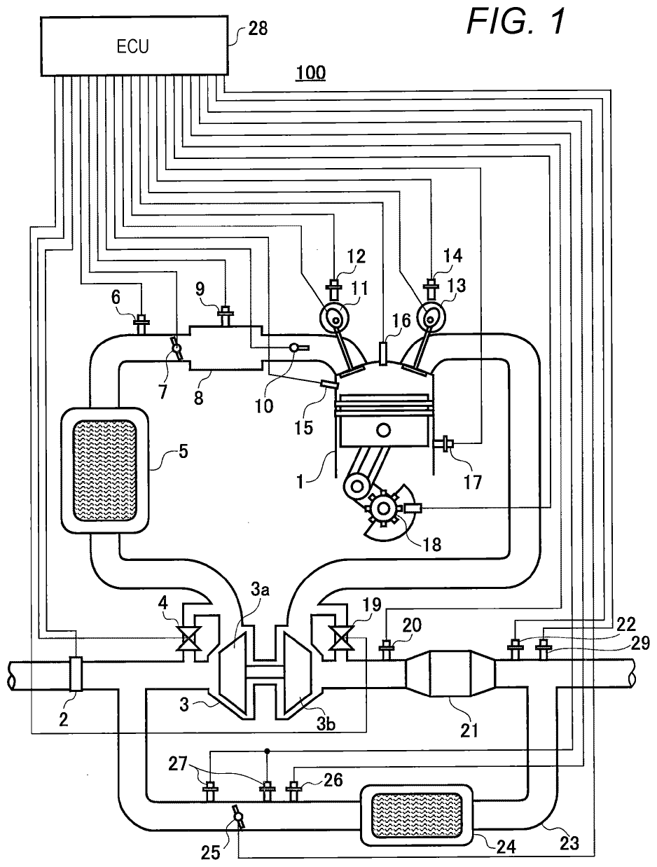

FIG. 1 is an overall schematic configuration diagram of an internal combustion engine control system 100.

The internal combustion engine control system 100 includes an internal combustion engine 1 and an electronic control unit (ECU) 28 attached to the internal combustion engine 1. The ECU 28 is electrically connected to various sensors, actuators, and the like constituting the internal combustion engine 1, and is an example of an internal combustion engine control device that controls the internal combustion engine 1.

The internal combustion engine 1 includes a flow rate sensor 2 (air flow sensor), a turbocharger 3, an air bypass valve 4, an intercooler 5, a supercharging temperature sensor 6, a throttle valve 7, an intake manifold 8, a supercharging pressure sensor 9, a flow enhancement valve 10, an intake valve 11, a valve opening and closing phase sensor 12, an exhaust valve 13, a valve opening and closing phase sensor 14, a fuel injection valve 15, an ignition plug 16, a knock sensor 17, a crank angle sensor 18, a wastegate valve 19, a catalyst upstream air-fuel ratio sensor 20, an exhaust purification catalyst (three-way catalyst) 21, a rear oxygen sensor (catalyst downstream oxygen sensor) 22, an exhausted gas recirculation (EGR) pipe 23, an EGR cooler 24, an EGR valve 25, an exhaust gas temperature sensor 26, a differential pressure sensor 27, and a catalyst downstream NOx sensor 29. Note that the rear oxygen sensor 22 can be replaced with a catalyst downstream (rear) air-fuel ratio sensor (not illustrated).

An intake air temperature sensor (not illustrated) is assembled to the flow rate sensor 2 provided in an intake flow path of the internal combustion engine 1. The intake air temperature sensor measures an intake air temperature.

The turbocharger 3 includes a compressor 3a including a compressor blade facing an intake flow path, and a turbine 3b including a turbine blade facing an exhaust flow path and connected to the compressor 3a so as to rotate integrally. The compressor 3a and the turbine 3b are rotatably supported inside the turbocharger 3. Then, the turbine 3b converts energy of exhaust gas from the internal combustion engine 1 into rotational energy. The compressor 3a connected to the turbine 3b compresses intake air flowing in from an intake flow path by rotational energy of the turbine 3b.

In an intake flow path of the internal combustion engine 1, the intercooler 5 is provided downstream of the compressor 3a of the turbocharger 3, and cools an intake air temperature of intake air that is adiabatically compressed and raised by the compressor 3a. The supercharging temperature sensor 6 is assembled downstream of the intercooler 5 and measures temperature (supercharging temperature) of the intake air cooled by the intercooler 5.

The throttle valve 7 is provided downstream of the intercooler 5, narrows an intake flow path, and controls an intake air amount flowing into a cylinder of the internal combustion engine 1. The throttle valve 7 is constituted by an electronically controlled butterfly valve for which valve opening degree can be controlled by the ECU 28. The intake manifold 8 to which the supercharging pressure sensor 9 is assembled communicates with the downstream side of the throttle valve 7.

Note that the intake manifold 8 provided downstream of the throttle valve 7 and the intercooler 5 may be configured to be integrated. In this case, since volume from the downstream side of the compressor 3a to a cylinder can be reduced, it is possible to improve the responsiveness and controllability of acceleration and deceleration.

The air bypass valve 4 is arranged on an intake bypass flow path connecting the upstream side and the downstream side of the compressor 3a in an intake flow path in order to prevent pressure from the downstream side of the compressor 3a to the upstream side of the throttle valve 7 from being excessively increased. For example, in a case where the throttle valve 7 is rapidly closed in a supercharged state, the air bypass valve 4 is opened according to control of the ECU 28, so that compressed intake air in a downstream portion of the compressor 3a flows back to an upstream portion of the compressor 3a through a bypass flow path. As a result, as supercharging pressure is immediately decreased, a phenomenon called surging can be prevented, and damage of the compressor 3a can be appropriately prevented.

The flow enhancement valve 10 is arranged downstream of the intake manifold 8, and enhances turbulence of flow inside a cylinder by causing flow deviation in intake air sucked into the cylinder. When exhaust gas recirculation combustion described later is performed, the ECU 28 closes the flow enhancement valve 10 to promote turbulent flow combustion so as to be able to stabilize combustion generated in a combustion chamber.

Each of the intake valve 11 and the exhaust valve 13 has a variable valve mechanism for continuously changing a phase of valve opening and closing. The valve opening and closing phase sensors 12 and 14 for detecting opening and closing phases of a valve are respectively assembled to variable valve mechanisms of the intake valve 11 and the exhaust valve 13. A cylinder of the internal combustion engine 1 includes the fuel injection valve 15 of a direct injection system that injects fuel pressurized by a fuel pump (not illustrated) into a combustion chamber of the cylinder. Note that the fuel injection valve 15 may be of a port injection system that injects fuel into an intake flow path. Alternatively, as the fuel injection valve 15, a plurality of the fuel injection valves 15 of a direct injection system and a port injection system may be used in combination for each cylinder.

In a cylinder of the internal combustion engine 1, the ignition plug 16 that exposes an electrode portion in the cylinder and ignites a combustible air-fuel mixture by spark is assembled. The knock sensor 17 is provided in a cylinder block, and detects the presence or absence of knock by detecting cylinder block vibration caused by combustion pressure vibration generated in a combustion chamber. The crank angle sensor 18 is assembled to a crankshaft and outputs a signal corresponding to a rotation angle of the crankshaft to the ECU 28.

In an exhaust pipe of the internal combustion engine 1, an upstream air-fuel ratio sensor (the catalyst upstream air-fuel ratio sensor 20) is arranged downstream of the turbine 3b of the turbocharger 3 and upstream of a three-way catalyst (the exhaust purification catalyst 21) that is provided in the exhaust pipe and has oxygen storage capacity. Then, the upstream air-fuel ratio sensor (catalyst upstream air-fuel ratio sensor 20) detects an exhaust gas composition detected from exhaust gas, that is, a catalyst upstream air-fuel ratio of the exhaust gas, and outputs a signal indicating the catalyst upstream air-fuel ratio to the ECU 28. The exhaust purification catalyst 21 is an example of a three-way catalyst, and is provided downstream of the catalyst upstream air-fuel ratio sensor 20. The exhaust purification catalyst 21 purifies harmful exhaust gas components such as carbon monoxide, a nitrogen compound, and unburned hydrocarbon in exhaust gas by a catalytic reaction. As described above, the rear oxygen sensor 22 is arranged downstream of the exhaust purification catalyst 21. The rear oxygen sensor 22 detects an amount of oxygen contained in exhaust gas after purification by the exhaust purification catalyst 21. Hereinafter, the exhaust purification catalyst 21 is also referred to as a three-way catalyst or a catalyst.

The turbocharger 3 includes the air bypass valve 4 and the wastegate valve 19. The air bypass valve 4 is arranged on a bypass flow path connecting the upstream side and the downstream side of the compressor 3a in order to prevent pressure from the downstream side of the compressor 3a to the upstream side of the throttle valve 7 from being excessively increased. In a case where the throttle valve 7 is rapidly closed in a supercharged state, the air bypass valve 4 is opened according to control of the ECU 28, so that compressed intake air in a downstream portion of the compressor 3a flows back to an upstream portion of the compressor 3a through a bypass flow path. As a result, as supercharging pressure is immediately decreased, a phenomenon called surging can be prevented, and damage of the compressor 3a can be appropriately prevented.

The wastegate valve 19 is arranged on an exhaust bypass flow path connecting the upstream side and the downstream side of the turbine 3b in an exhaust flow path. The wastegate valve 19 is an electric valve whose valve opening degree can be freely controlled with respect to supercharging pressure by control of the ECU 28. When opening degree of the wastegate valve 19 is adjusted by the ECU 28 based on supercharging pressure detected by the supercharging pressure sensor 9, a part of exhaust gas passes through a bypass flow path, so that energy given to the turbine 3b by exhaust gas can be reduced. As a result, the wastegate valve 19 can adjust supercharging pressure to a target pressure.

The EGR pipe 23 allows an exhaust flow path in a downstream portion of the exhaust purification catalyst 21 and an intake flow path in an upstream portion of the compressor 3a to communicate with each other, divides exhaust gas from the downstream side of the exhaust purification catalyst 21, and returns the exhaust gas to the upstream portion of the compressor 3a. The EGR cooler 24 provided in the EGR pipe 23 cools the divided exhaust gas. The EGR valve 25 is provided between the EGR cooler 24 and the upstream portion of the compressor 3a in the EGR pipe 23, and controls a flow rate of exhaust gas recirculating to the upstream portion of the compressor 3a. Further, the EGR pipe 23 is provided with the exhaust gas temperature sensor 26 that detects exhaust gas temperature of exhaust gas in an upstream portion of the EGR valve 25 and the differential pressure sensor 27 that detects differential pressure between the upstream side and the downstream side of the EGR valve 25.

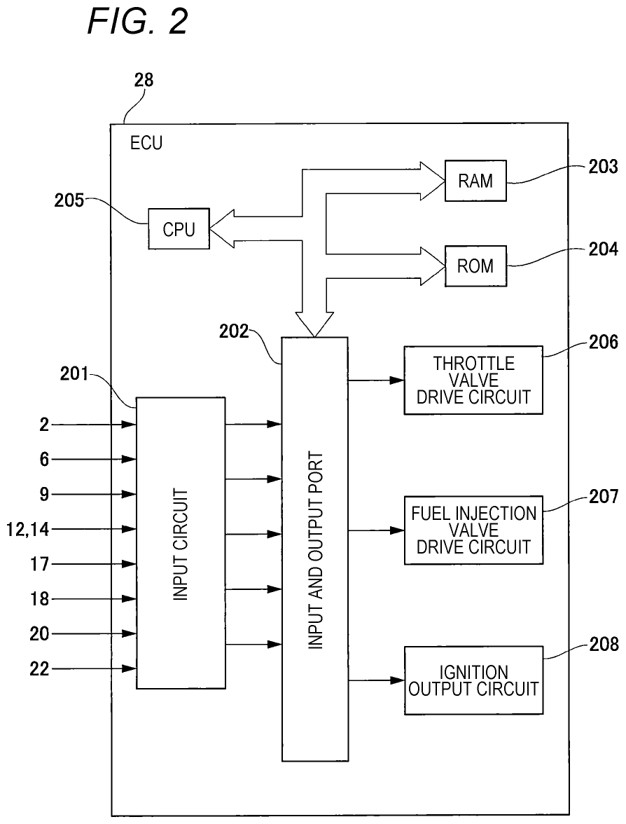

The ECU 28 includes an analog-to-digital (A/D) converter (not illustrated), a driver circuit, and the like in addition to a central processing unit (CPU) 205, a read only memory (ROM) 204, and a random access memory (RAM) 203 illustrated in FIG. 2 to be described later, and is a control device that controls each constituent element of the internal combustion engine 1 and executes various types of data processing. The ECU 28 controls, for example, operation of actuators of the throttle valve 7, the fuel injection valve 15, variable valve mechanisms of the intake valve 11 and the exhaust valve 13, the EGR valve 25, and the like. Further, the ECU 28 detects an operation state of the internal combustion engine 1 based on a signal input from various sensors, and causes the ignition plug 16 to ignite at a timing determined according to the operation state.

### [Hardware Configuration Example of ECU]

FIG. 2 is a block diagram illustrating a hardware configuration example of the ECU 28.

The ECU 28 includes an input circuit 201, an input and output port 202, a RAM 203, a ROM 204, a CPU 205, a throttle valve drive circuit 206, a combustion injection valve drive circuit 207, and an ignition output circuit 208.

Output signals from various sensors are input to the input circuit 201. FIG. 2 illustrates an example in which output signals of a throttle sensor of the throttle valve 7, the flow rate sensor 2, the supercharging temperature sensor 6, the supercharging pressure sensor 9, the valve opening and closing phase sensors 12 and 14, the knock sensor 17, the crank angle sensor 18, the catalyst upstream air-fuel ratio sensor 20, the rear oxygen sensor 22, and the like are input to the input circuit 201 of the ECU 28. A signal input to the input circuit 201 is transmitted to the input and output port 202.

A signal transmitted to the input and output port 202 is stored in the RAM 203 and is subjected to arithmetic processing by the CPU 205. A control program describing content of arithmetic processing is written in advance in the ROM 204 and is executed by the CPU 205. The ROM 204 records a program, data, and the like necessary for operation of the CPU 205, and is used as an example of a computer-readable non-transitory storage medium storing a program executed by the ECU 28.

A control signal calculated by the CPU 205 according to a control program is output to each device such as the throttle valve drive circuit 206, the combustion injection valve drive circuit 207, and the ignition output circuit 208.

The throttle valve drive circuit 206 outputs a drive signal for controlling opening and closing drive of the throttle valve 7 to the throttle valve 7.

The combustion injection valve drive circuit 207 outputs a drive signal for controlling opening and closing drive of the fuel injection valve 15 at a fuel injection timing to the fuel injection valve 15.

The ignition output circuit 208 outputs a drive signal for controlling ignition of the ignition plug 16 at an ignition timing to the ignition output circuit 208.

### <Configuration Example of Aftertreatment System>

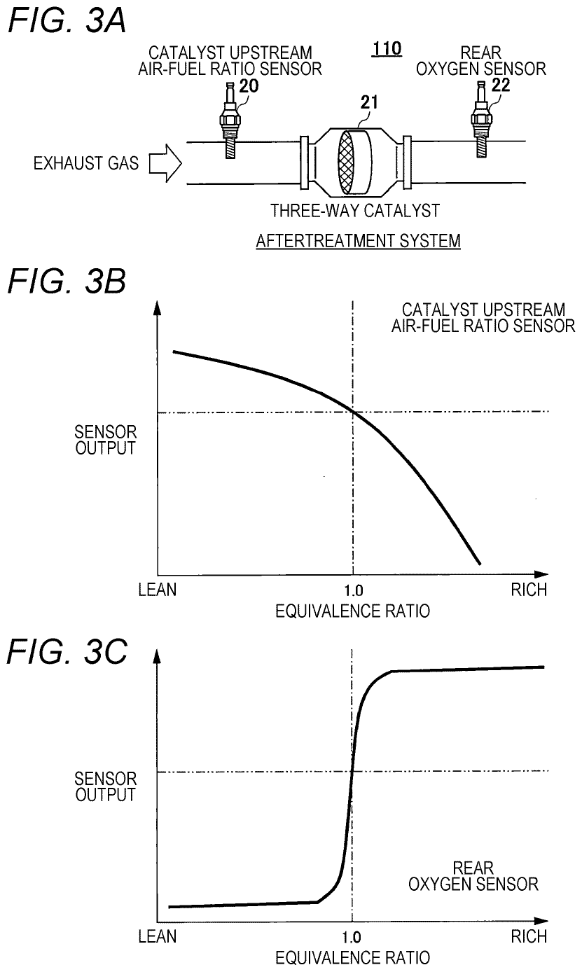

Next, a configuration example of a known aftertreatment system 110 that purifies exhaust gas of an internal combustion engine will be described with reference to FIGS. 3A to 3C.

FIG. 3A is a schematic diagram illustrating a configuration example of the aftertreatment system 110.

As described above, in the aftertreatment system 110, a three-way catalyst is used as an exhaust gas purification catalyst (the exhaust purification catalyst 21). The catalyst upstream air-fuel ratio sensor 20 is provided in an upstream portion of the three-way catalyst, the rear oxygen sensor 22 is provided in a downstream portion, and the catalyst upstream air-fuel ratio sensor 20 and the rear oxygen sensor 22 are connected to a control device such as the ECU 28. The ECU 28 can measure a catalyst upstream air-fuel ratio of exhaust gas flowing into the three-way catalyst via the catalyst upstream air-fuel ratio sensor 20 and detect an amount of oxygen contained in exhaust gas after catalyst purification via the rear oxygen sensor 22.

FIG. 3B is a diagram for explaining a relationship between an equivalence ratio (=stoichiometric air-fuel ratio/air-fuel ratio) of exhaust gas and output of the catalyst upstream air-fuel ratio sensor 20. In FIG. 3B, the horizontal axis represents the equivalence ratio, and the vertical axis represents the output of the catalyst upstream air-fuel ratio sensor 20.

As illustrated in FIG. 3B, the output of the catalyst upstream air-fuel ratio sensor 20 (air-fuel ratio sensor output) tends to decrease as the equivalence ratio increases (in other words, as the exhaust gas becomes richer). The ECU 28 converts a catalyst upstream air-fuel ratio sensor signal into a catalyst upstream air-fuel ratio based on a relationship between the equivalence ratio of exhaust gas and the output of the catalyst upstream air-fuel ratio sensor 20. By this, the ECU 28 can accurately detect a catalyst upstream air-fuel ratio in a wide range from a lean state to a rich state of exhaust gas.

FIG. 3C is a diagram for explaining a relationship between an equivalence ratio of exhaust gas and output of the rear oxygen sensor 22. In FIG. 3C, the horizontal axis represents the equivalence ratio, and the vertical axis represents the rear oxygen sensor output.

The rear oxygen sensor output is also read as rear oxygen sensor voltage, and is changed by electromotive force accompanying a concentration difference between oxygen concentration contained in exhaust gas and oxygen concentration in air. The rear oxygen sensor output shows substantially minimum electromotive force in a lean condition, and shows maximum electromotive force in a rich condition. For this reason, in catalyst control, the rear oxygen sensor output has a characteristic of rapidly changing at a stoichiometric air-fuel ratio (equivalence ratio of 1.0). The ECU 28 can detect an amount of oxygen of exhaust gas released downstream of a three-way catalyst by capturing a change timing of the rear oxygen sensor output.

### <Chemical Species Concentration of Exhaust Gas>

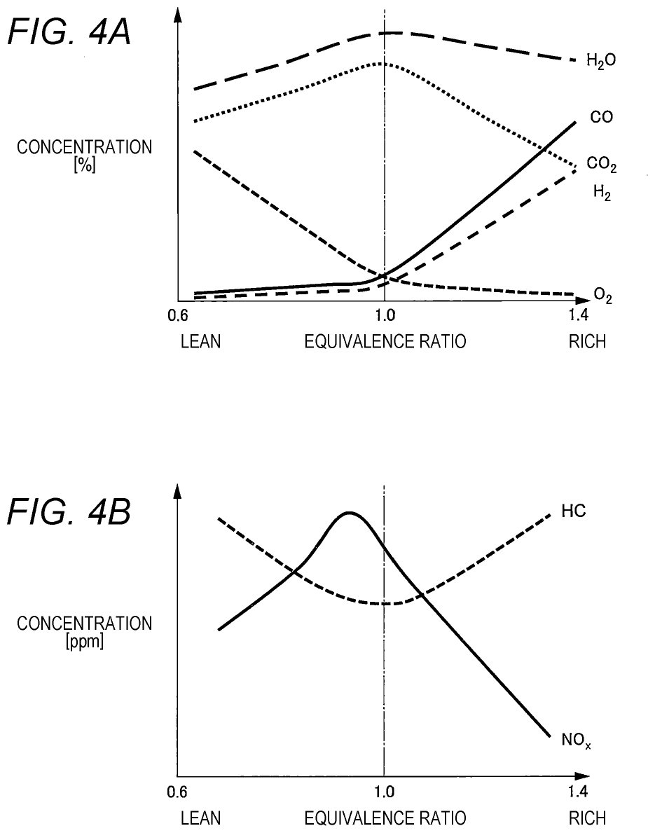

FIGS. 4A and 4B are diagrams for explaining a tendency of chemical species concentration of exhaust gas with respect to an equivalence ratio.

FIG. 4A is a diagram illustrating a tendency with respect to an equivalence ratio of H₂O (water), CO (carbon monoxide), CO₂ (carbon dioxide), H₂ (hydrogen), and O₂ (oxygen).

FIG. 4B is a diagram illustrating a tendency with respect to an equivalence ratio of HC (hydrocarbon) and NOx (nitrogen oxide). In FIGS. 4A and 4B, the horizontal axis represents the equivalence ratio, and the vertical axis represents the concentration of chemical species of exhaust gas.

As illustrated in FIG. 4A, a combustion gas composition of hydrocarbon-based fuel shows a tendency that CO (carbon monoxide) and H₂ (hydrogen) increase on the rich side and O₂ (oxygen) increases on the lean side with a stoichiometric air-fuel ratio as a boundary. On the other hand, as illustrated in FIG. 4B, NOx (nitrogen oxide) shows a maximum value on a slightly lean side of the stoichiometric air-fuel ratio, and tends to decrease on the lean side and the rich side. HC (unburned hydrocarbon) is an unburned fuel component that is emitted without reaching combustion, and shows a minimum value in the stoichiometric air-fuel ratio, and when becoming excessively lean or rich with the stoichiometric air-fuel ratio as a boundary, fuel does not reach complete combustion and an amount of emitted HC tends to increase.

As illustrated in FIGS. 4A and 4B, even under a stoichiometric air-fuel ratio condition where fuel and air (oxygen) are supplied without excess or deficiency, a certain amount of CO (carbon monoxide) or NOx (nitrogen oxide) is emitted without reaching H₂O (water) or CO₂ (carbon dioxide) in high-temperature combustion gas. For this reason, it is necessary to properly perform purification processing of exhaust gas by the aftertreatment system 110.

### <Reaction Process of Three-Way Catalyst>

FIG. 5 is a diagram for explaining a main reaction process of a three-way catalyst (ceria-based) used in the aftertreatment system 110. In the reaction process illustrated in FIG. 5, description of coefficients is omitted.

A three-way catalytic reaction process mainly includes an oxidation reaction, an NOx reduction reaction, and an oxygen storage and release reaction. In the oxidation reaction, CO, H₂, and HC generated under a rich condition or a high temperature condition react with oxygen and harmless CO₂ and H₂O are generated. Unburned hydrocarbon (HC) contains components such as methane, propane, ethylene, and butane, and reaction proceeds at different rates.

The NOx reduction reaction is mainly represented by a reaction between CO and NO, and CO₂ and N₂ are generated.

In the oxygen storage and release reaction, storage and release of oxygen (O₂) and each oxidation and reduction reaction of HC, CO, and NO proceed via Ce (cerium) which is a catalyst material. That is, CO₂ and H₂O are generated by the reaction of cerium dioxide (CeO₂) with CO and HC, and N₂ is generated by the reaction of cerium(III) oxide (Ce₂O₃) with NO. At this time, an oxygen storage ratio Ψ of the three-way catalyst is defined by the balance between CeO₂ and Ce₂O₃ generated simultaneously. That is, when all of Ce₂O₃ in the catalyst becomes CeO₂, a reaction with NO cannot be performed, and NO cannot be purified.

As described above, in order to appropriately maintain a purification rate of the three-way catalyst, it is necessary to maintain the balance between CeO₂ and Ce₂O₃, that is, the oxygen storage ratio Ψ at a predetermined value. Since all the above-described reaction processes strongly depend on catalyst temperature, the ECU 28 needs to appropriately perform catalyst temperature management so that the temperature becomes equal to or more than activation temperature early after the start of the internal combustion engine 1.

Note that in the system shown in the present embodiment, a ceria-based three-way catalyst is used, but the present invention is not limited to this. Even in a catalyst using another material exhibiting a similar effect, the same effect can be exhibited without change in the configuration of the invention by adjustment of a constant of a control model. Further, in a catalytic reaction, an aqueous gas shift reaction or the like may be used in addition to the reaction mechanism illustrated in FIG. 5. The ECU 28 can also cope with these reaction mechanisms by adjusting a control model constant.

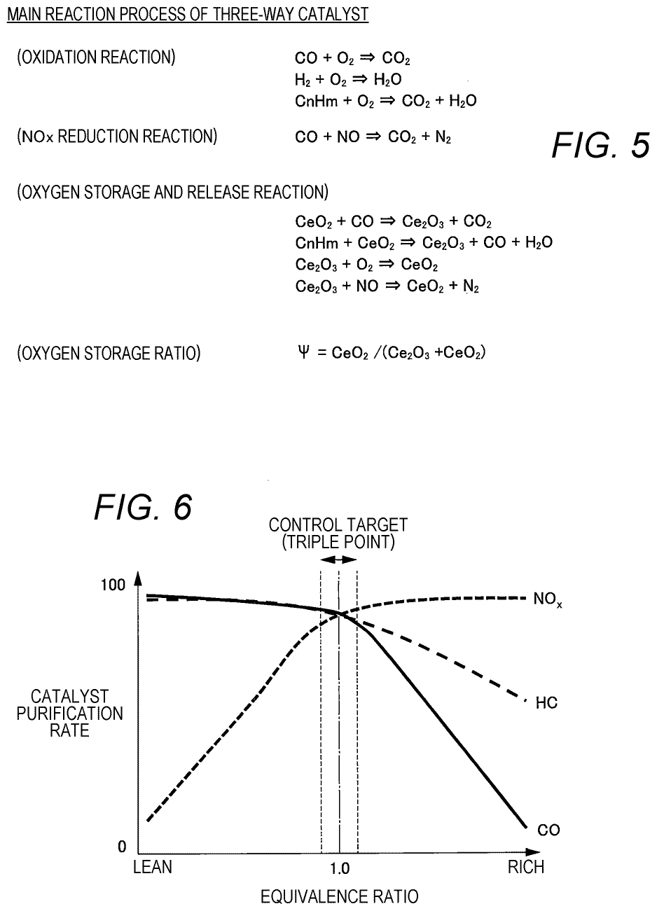

FIG. 6 is a diagram for explaining a tendency of a purification rate of a three-way catalyst with respect to an exhaust gas equivalence ratio at catalyst activation temperature or more. In FIG. 6, the horizontal axis represents the equivalence ratio, and the vertical axis represents the catalyst purification rate. Then, FIG. 6 shows catalyst purification rates of NOx, HC, and CO in a case where the equivalence ratio changes from lean to rich. Further, the catalyst purification rate closer to 100% indicates that a component in exhaust gas is purified more and the component in the exhaust gas is less emitted.

This graph shows that a purification rate characteristic of the three-way catalyst changes with a stoichiometric air-fuel ratio (“control target” in the diagram) as a boundary. Under a lean condition, while a purification rate of CO and HC is maintained at about 90% or more, an NOx purification rate decreases as the equivalence ratio decreases. On the rich side, purification rates of HC and CO tend to decrease as the equivalence ratio increases. In the vicinity of the stoichiometric air-fuel ratio, a purification rate of any of NOx, HC, and CO can achieve 90% or more. In view of the above, a point near the stoichiometric air-fuel ratio is referred to as a “triple point”. The ECU 28 performs control to keep a purification rate of the three-way catalyst high by keeping the equivalence ratio at the stoichiometric air-fuel ratio which is the triple point.

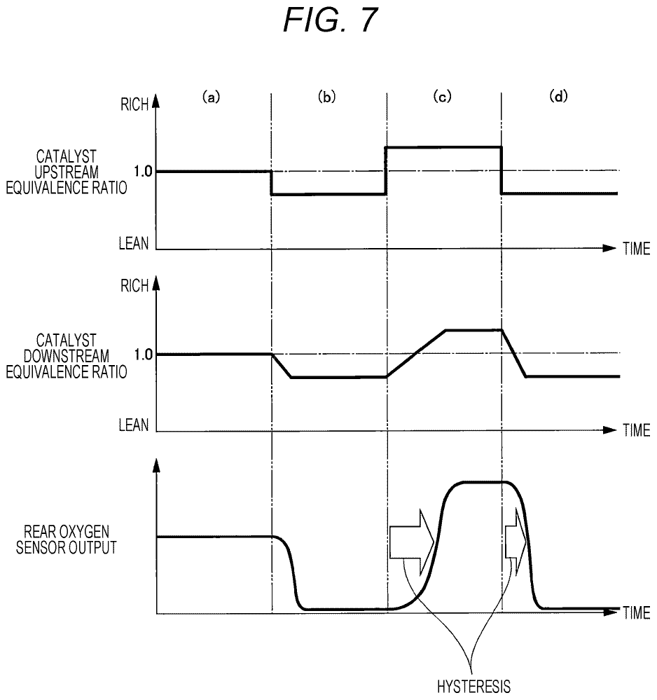

FIG. 7 is a diagram for explaining a catalyst upstream equivalence ratio, a catalyst downstream equivalence ratio, and output behavior of the rear oxygen sensor 22. In FIG. 7, the horizontal axis represents time, and the vertical axis represents the catalyst upstream equivalence ratio, the catalyst downstream equivalence ratio, and the rear oxygen sensor output. Here, an equivalence ratio (catalyst downstream air-fuel ratio) on the downstream side of the catalyst and output behavior of the rear oxygen sensor 22 installed on the downstream side of the catalyst when a catalyst upstream equivalence ratio (catalyst upstream air-fuel ratio) is rapidly changed stepwise (stepwise manner) in terms of time to the lean side or the rich side with the equivalence ratio of 1.0 as the center are shown.

First, as shown in a time zone (a) along the time axis in the left-right direction in FIG. 7, in a case where the catalyst upstream equivalence ratio is set to exactly 1.0, a very small amount of oxygen is emitted downstream of the catalyst. For this reason, the rear oxygen sensor output is held in an intermediate state that is a value between its maximum electromotive force and minimum electromotive force.

Subsequently, as shown in a time zone (b) in FIG. 7, when the catalyst upstream equivalence ratio is decreased from the equivalence ratio of 1.0 and changed stepwise to the lean side, the catalyst downstream equivalence ratio gradually decreases to the lean side, and the rear oxygen sensor output rapidly changes to the predetermined minimum electromotive force value side under a lean condition after relaxation time required for gradual decrease of the catalyst downstream equivalence ratio.

Further subsequently, as shown in a time zone (c) in FIG. 7, when the catalyst upstream equivalence ratio is increased to be more than the equivalence ratio of 1.0 and changed stepwise to the rich side, the catalyst downstream equivalence ratio starts gradually increasing to the rich side accordingly. The rear oxygen sensor output changes to the predetermined maximum electromotive force value side under a rich condition after relaxation time required for gradual increase of the catalyst downstream equivalence ratio.

Next, as shown in a time zone (d) in FIG. 7, when the catalyst upstream equivalence ratio is decreased again from the equivalence ratio of 1.0 and changed stepwise to the lean side, the catalyst downstream equivalence ratio gradually decreases again to the lean side. The rear oxygen sensor output corresponding to a change in the catalyst upstream equivalence ratio changes to the predetermined minimum electromotive force value side under a lean condition again after relaxation time required for gradual decrease in the catalyst downstream equivalence ratio. Time required for a change from rich to lean in the catalyst downstream equivalence ratio in the time zone (d) is shorter than time required for a change from lean to rich in the time zone (c), that is, has what is called hysteresis.

As described above, in the change from lean to rich and the change from rich to lean, delay time of the catalyst downstream equivalence ratio and delay time of the output of the rear oxygen sensor 22 tend to be different. This tendency is caused by the fact that reaction rates in the oxygen storage and release reaction of CeO₂ and Ce₂O₃ of the three-way catalyst (ceria-based) described in FIG. 5 are different depending on the change from rich to lean and the change from lean to rich. Further, since a reaction rate of the three-way catalyst also depends on catalyst temperature and an exhaust gas flow rate, the hysteresis described above changes depending on the catalyst temperature and the exhaust gas flow rate.

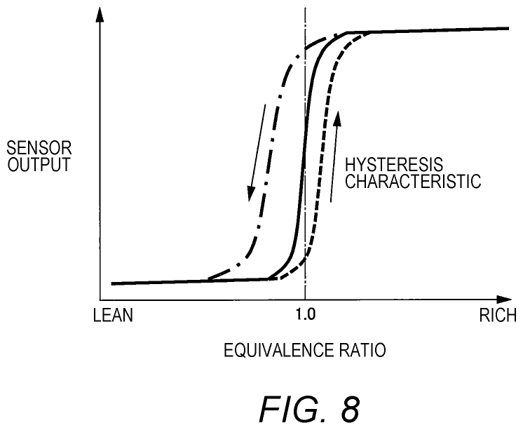

Next, hysteresis of an oxygen sensor characteristic will be described with reference to FIG. 8.

FIG. 8 is a diagram for explaining hysteresis of an output characteristic of the oxygen sensor. In this graph, the horizontal axis represents an equivalence ratio, and the vertical axis represents output of the oxygen sensor.

A static characteristic of the oxygen sensor is as described with reference to FIG. 3C. On the other hand, the above-described catalyst material is also used for the oxygen sensor. Therefore, a dynamic characteristic of the oxygen sensor has hysteresis in which a change from rich to lean and a change from lean to rich are different. That is, relaxation time required when an oxygen sensor signal changes from the predetermined maximum electromotive force value side under a rich condition to the predetermined minimum electromotive force value side under a lean condition is shorter than relaxation time required when the oxygen sensor signal changes from the predetermined minimum electromotive force value side under the lean condition to the predetermined maximum electromotive force value side under the rich condition. Furthermore, behavior of the oxygen sensor signal described above is affected by a change in a use process of a material characteristic constituting the oxygen sensor and temperature of the oxygen sensor.

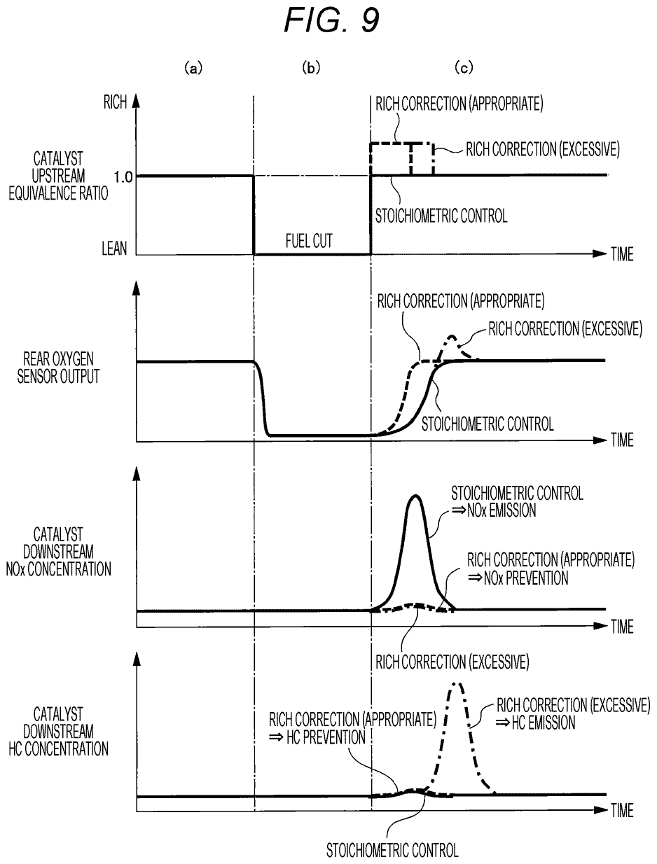

Here, with reference also to FIG. 9, a temporal change of output of the rear oxygen sensor 22 and catalyst downstream NOx concentration in a case where operation is returned in the stoichiometric air-fuel ratio state again from a state (stoichiometric control) in which the internal combustion engine 1 is controlled at the catalyst upstream equivalence ratio of 1.0 (stoichiometric air-fuel ratio) through a period (lean condition) in which fuel cut is performed will be described.

FIG. 9 is a diagram for explaining temporal changes in the output of the rear oxygen sensor 22 and NOx concentration and HC concentration downstream of the catalyst. In FIG. 9, the horizontal axis represents time, and the vertical axis represents the catalyst upstream equivalence ratio, the rear oxygen sensor output, the catalyst downstream NOx concentration, and the catalyst downstream HC concentration.

First, in a case where the catalyst upstream equivalence ratio is set to exactly 1.0 as shown in a time zone (a) along the time axis in the left-right direction in FIG. 9, the rear oxygen sensor output is held in an intermediate state that is a value between its maximum electromotive force and minimum electromotive force.

Subsequently, as shown in a time zone (b) in FIG. 9, operation with the catalyst upstream equivalence ratio of 1.0 is shifted to a lean condition by fuel cut.

Subsequently, as shown in a time zone (c) in FIG. 9, the operation returns to the operation with the catalyst upstream equivalence ratio of 1.0 again. At this time, a change from the intermediate state of the catalyst upstream equivalence ratio of 1.0 of the rear oxygen sensor output to the lean side and a change from the lean side to the intermediate state of the catalyst upstream equivalence ratio of 1.0 (relaxation time) are different.

That is, relaxation time required when an oxygen sensor signal changes from the predetermined minimum electromotive force value side under the lean condition by fuel cut to the intermediate state (see the time zone (a) in FIG. 7) under the stoichiometric control condition is longer than relaxation time required when the oxygen sensor signal changes from the intermediate state under the stoichiometric control condition to the predetermined minimum electromotive force value side under the lean condition. During the relaxation time (delay period) until the rear oxygen sensor output returns to the intermediate state, behavior in which NOx concentration downstream of the catalyst increases in a spike manner may be observed.

To cope with such an increase in the NOx concentration downstream of the catalyst, for example, control is performed by performing what is called rich correction to temporarily increase a catalyst purification rate of NOx by increasing the catalyst upstream equivalence ratio to be more than the equivalence ratio of 1.0 (see FIG. 6) so as to reduce an NOx emission amount downstream of the catalyst when operation with the catalyst upstream equivalence ratio of 1.0 is started again after fuel cut. However, there is a trade-off relationship between increasing a catalyst purification rate of NOx by the rich correction and catalyst purification rates of HC and CO (see FIG. 6). For this reason, in air-fuel ratio control of the internal combustion engine 1, it is necessary to perform rich correction control with an appropriate correction amount and in an appropriate period in consideration of a state inside the catalyst. Note that, in order to consider a state inside the catalyst in air-fuel ratio control of the internal combustion engine 1, for example, a rear oxygen sensor signal that detects an oxygen state of exhaust gas downstream of the catalyst can be used as a determination reference. However, as described above, it should be noted that a reaction of the rear oxygen sensor 22 has a delay period (see FIG. 8).

Here, temporal changes in the output of the rear oxygen sensor 22 and the NOx concentration and the HC concentration downstream of the catalyst will be described in the order of stoichiometric control, appropriate rich correction, and excessive rich correction.

### (Stoichiometric Control)

Temporal changes of the output of the rear oxygen sensor 22 and the NOx concentration and the HC concentration downstream of the catalyst when the stoichiometric control is performed are indicated by solid lines. As illustrated in FIG. 7, the output of the rear oxygen sensor 22 increases with a delay with respect to a change from the lean state to the rich state. The NOx concentration downstream of the catalyst indicates behavior in which momentarily increased NOx is emitted during a delay period until the output of the rear oxygen sensor 22 returns. On the other hand, since the HC concentration downstream of the catalyst is substantially unchanged, emission of HC is prevented.

### (Appropriate Rich Correction)

Temporal changes of the output of the rear oxygen sensor 22 and the NOx concentration and the HC concentration downstream of the catalyst when the appropriate rich correction is performed are indicated by broken lines. When firing operation is started again after fuel cut, once the rich correction is performed, a catalyst upstream equivalence ratio becomes a rich state. The output of the rear oxygen sensor 22 reaches the equivalence ratio earlier than the stoichiometric control. Further, since the NOx concentration and the HC concentration downstream of the catalyst are substantially unchanged, emission of NOx and HC is prevented.

### (Excessive Rich Correction)

Temporal changes of the output of the rear oxygen sensor 22 and the NOx concentration and the HC concentration downstream of the catalyst when excessive rich correction is performed are indicated by rough broken lines. The rear oxygen sensor 22 detects an oxygen state of downstream gas of the catalyst. For this reason, when the excessive rich correction is performed, at a time point at which the output of the rear oxygen sensor 22 reacts, as an internal state of the catalyst, an oxygen storage state has already changed to a maximum or minimum state. Further, when the excessive rich correction is performed, the NOx concentration decreases as illustrated in FIG. 4B, and the catalyst purification rate of NOx increases as illustrated in FIG. 6, so that emission of NOx is prevented.

On the other hand, since the HC concentration increases as illustrated in FIG. 4B and the catalyst purification rate of HC decreases as illustrated in FIG. 6, HC is emitted. That is, when a control method of stopping the rich correction after the output of the rear oxygen sensor 22 reacts is employed, HC cannot be appropriately prevented because a stop timing of the rich correction is too late for the catalyst. For this reason, in air-fuel ratio control of an internal combustion engine, it is necessary to perform rich correction control for an appropriate period in consideration of a state inside the catalyst that cannot be directly observed from the outside.

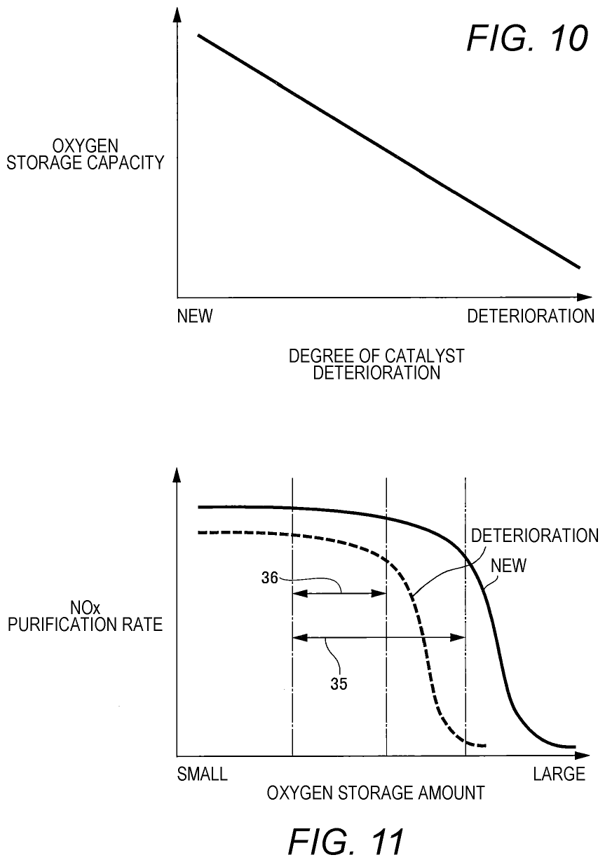

FIG. 10 is a diagram for explaining a relationship between degree of catalyst deterioration and oxygen storage capacity (OSC) of a three-way catalyst. In FIG. 10, the horizontal axis represents the degree of catalyst deterioration, and the vertical axis represents the oxygen storage capacity.

The catalyst deterioration refers to a state in which a catalytic action of a three-way catalyst is reduced due to thermal influence and influence of poisoning by sulfur contained in fuel. As illustrated in FIG. 10, the oxygen storage capacity of the three-way catalyst is substantially proportional to the degree of catalyst deterioration in a left-right direction in FIG. 10. That is, the oxygen storage capacity of the three-way catalyst tends to decrease as the catalyst deterioration progresses.

Hereinafter, influence of a change in the oxygen storage capacity on a purification action of the three-way catalyst will be described.

FIG. 11 is a diagram for explaining a relationship between an oxygen storage ratio of the three-way catalyst, that is, a value obtained by dividing a current oxygen storage amount of the three-way catalyst by the above-described oxygen storage capacity, and the NOx purification rate. In FIG. 11, the horizontal axis represents the oxygen storage ratio, and the vertical axis represents the NOx purification rate. In FIG. 11, a change in the NOx purification rate of a new three-way catalyst is represented by a solid line, and a change in the NOx purification rate of a deteriorated three-way catalyst is represented by a broken line.

When the oxygen storage ratio is small, both the new three-way catalyst and the deteriorated three-way catalyst have a high oxygen storage ratio. Further, the new three-way catalyst has a higher NOx purification rate than the deteriorated three-way catalyst.

As illustrated in FIG. 11, when the oxygen storage ratio exceeds a predetermined value, NOx purification rates of both the new three-way catalyst and the deteriorated three-way catalyst tend to deteriorate rapidly. This is because, as described with reference to FIG. 5, Ce₂O₃ in the catalyst is important for NOx purification, and when all of Ce₂O₃ reacts and changes to CeO₂, Ce₂O₃ cannot react with NO, and NOx cannot be purified. Further, when the oxygen storage capacity of the three-way catalyst decreases as the catalyst deterioration progresses, as a result, a value of the oxygen storage ratio with respect to the same oxygen storage amount increases.

For this reason, regarding a value of the NOx purification rate with respect to the oxygen storage amount, the NOx purification rate of the deteriorated three-way catalyst indicated by the broken line in FIG. 11 is lower than the NOx purification rate of the new three-way catalyst indicated by the solid line in FIG. 11. Therefore, in order to keep the NOx purification rate high, it is necessary not only to keep an exhaust gas air-fuel ratio at the catalyst inlet at the triple point but also to appropriately correct and control the exhaust gas air-fuel ratio at the catalyst inlet so that the oxygen storage ratio is within a range in which a predetermined NOx purification rate can be obtained in consideration of a state inside the catalyst that cannot be directly observed from the outside, that is, current oxygen storage capacity and oxygen storage ratio of the three-way catalyst. Note that, as illustrated in FIG. 11, a predetermined range of the oxygen storage ratio is expressed as a deteriorated catalyst control range 36 when the catalyst is deteriorated and a new catalyst control range 35 when the catalyst is new, and the new catalyst control range 35 is wider than the deteriorated catalyst control range 36.

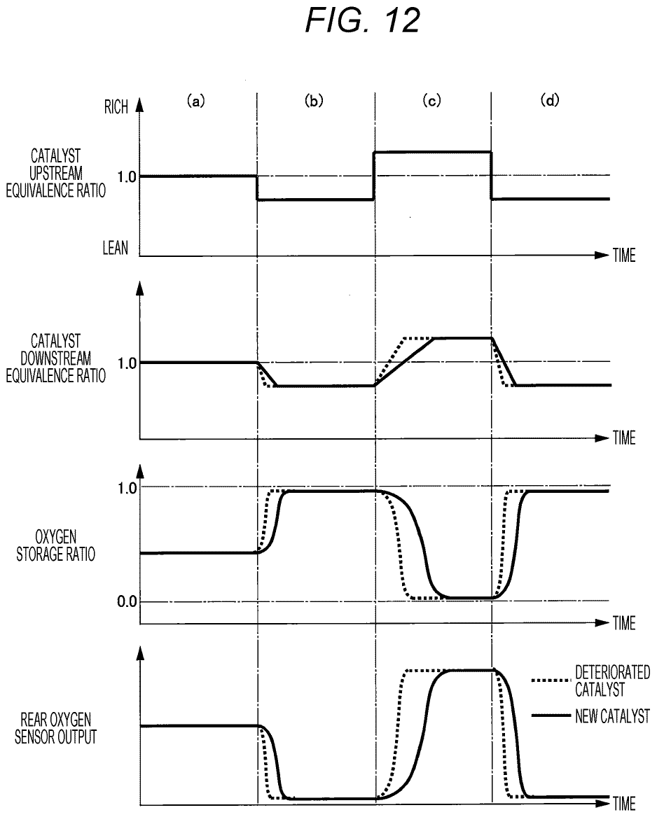

FIG. 12 is a diagram for explaining a comparison result of a catalyst upstream equivalence ratio, a catalyst downstream equivalence ratio, an oxygen storage ratio, and output behavior of the rear oxygen sensor 22 in a case where a deteriorated catalyst and a new catalyst are used. In FIG. 12, the horizontal axis represents time, and the vertical axis represents a catalyst upstream equivalence ratio, a catalyst downstream equivalence ratio, an oxygen storage ratio, and rear oxygen sensor output. FIG. 12 illustrates a comparison result of output behavior of the rear oxygen sensor 22 installed downstream of the catalyst when the air-fuel ratio is temporally changed stepwise to the lean side and the rich side around the equivalence ratio of 1.0 in the new catalyst and the deteriorated catalyst. Note that a broken line graph in the diagram represents the deteriorated catalyst, and a solid line graph represents the new catalyst.

As illustrated in FIG. 12, in the deteriorated catalyst, a delay of the output behavior of the rear oxygen sensor 22 with respect to the lean change and the rich change of the catalyst downstream equivalence ratio is reduced as compared with the new catalyst. This can be explained by a temporal transition of the oxygen storage ratio of the catalyst. That is, this is because the oxygen storage capacity of the catalyst decreases due to deterioration, and the oxygen storage ratio is saturated to a maximum value or a minimum value more quickly, so that an oxygen storage and release reaction period of the catalyst to exhaust gas downstream of the catalyst decreases. Therefore, a rich correction period after return from fuel cut described with reference to FIG. 9 needs to be set in consideration of a deterioration state of the catalyst.

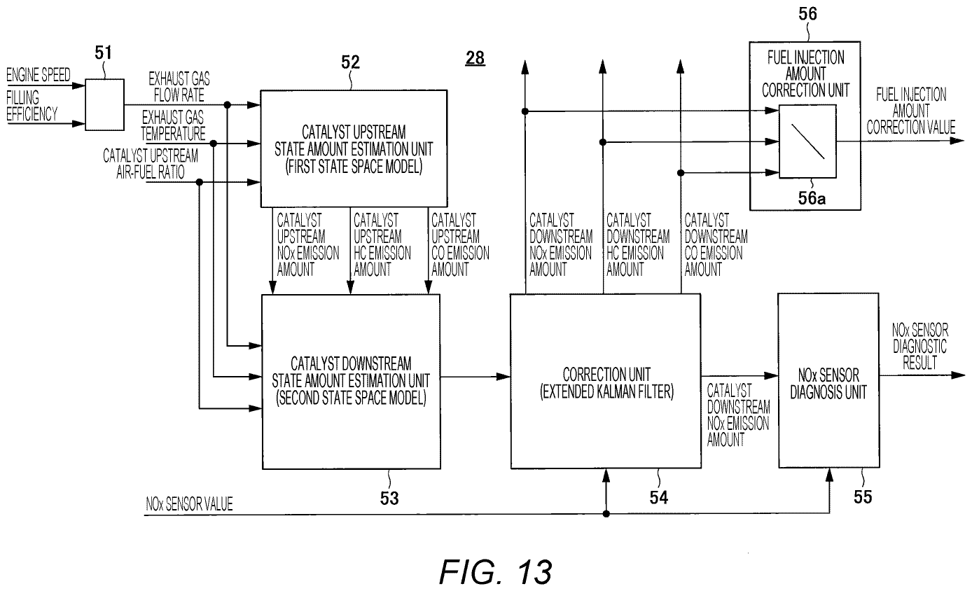

FIG. 13 is a block diagram illustrating an internal configuration example of the ECU 28 according to the present invention. The ECU 28 includes blocks 51 to 56 below.

An exhaust gas flow rate calculation unit (exhaust gas flow rate calculation unit 51) calculates an exhaust gas flow rate of exhaust gas by using an engine speed based on the crank angle sensor 18 and filling efficiency based on the flow rate sensor 2 as inputs.

A catalyst upstream state amount estimation unit 52 estimates state amounts (a catalyst upstream NOx emission amount, a catalyst upstream HC emission amount, and a catalyst upstream CO emission amount) of various substances emitted on the upstream side of the three-way catalyst. In description below, the catalyst upstream NOx emission amount, the catalyst upstream HC emission amount, and the catalyst upstream CO emission amount are also abbreviated as “catalyst upstream NOx, HC, and CO emission amounts”. The catalyst upstream state amount estimation unit (catalyst upstream state amount estimation unit 52) uses a catalyst upstream air-fuel ratio detected by the catalyst upstream air-fuel ratio sensor 20, an exhaust gas flow rate, and exhaust gas temperature detected by the exhaust gas temperature sensor 26 as inputs, and estimates the catalyst upstream NOx, HC, and CO emission amounts as a catalyst upstream state amount. The catalyst upstream state amount estimation unit 52 is configured by a first state space model. The first state space model is configured by, for example, a first machine learning model (neural network model) to be described later. Then, the catalyst upstream state amount estimation unit (catalyst upstream state amount estimation unit 52) inputs the catalyst upstream air-fuel ratio, the exhaust gas flow rate, and the exhaust gas temperature to the first machine learning model trained in advance, and estimates the catalyst upstream NOx, HC, and CO emission amounts output by the first machine learning model as the catalyst upstream state amount.

A catalyst downstream state amount estimation unit 53 estimates state amounts (a catalyst downstream NOx emission amount, a catalyst downstream HC emission amount, a catalyst downstream CO emission amount, an oxygen storage ratio, a catalyst downstream air-fuel ratio, and catalyst temperature) of various substances emitted on the downstream side of the three-way catalyst. In description below, the catalyst downstream NOx emission amount, the catalyst downstream HC emission amount, and the catalyst downstream CO emission amount are also abbreviated as “catalyst downstream NOx, HC, and CO emission amounts”. The catalyst downstream state amount estimation unit 53 uses the catalyst upstream air-fuel ratio, the exhaust gas flow rate, the exhaust gas temperature, and the catalyst upstream state amount (catalyst upstream NOx, HC, and CO emission amounts) as inputs, and estimates catalyst temperature of the three-way catalyst, the oxygen storage capacity, the catalyst downstream air-fuel ratio (rear equivalence ratio), and the catalyst downstream NOx, HC, and CO emission amounts as a catalyst downstream state amount. The catalyst downstream state amount estimation unit 53 is configured by a second state space model. The second state space model is configured by, for example, a second machine learning model (neural network model different from the first state space model configured by the catalyst upstream state amount estimation unit 52). Then, the catalyst downstream state amount estimation unit (catalyst downstream state amount estimation unit 53) inputs the catalyst upstream air-fuel ratio, the exhaust gas flow rate, the exhaust gas temperature, and the catalyst upstream state amount to the second machine learning model trained in advance, and estimates the catalyst temperature, the oxygen storage capacity, the catalyst downstream air-fuel ratio, and the catalyst downstream NOx, HC, and CO emission amounts of the three-way catalyst output by the second machine learning model as the catalyst downstream state amount.

A correction unit (correction unit 54) corrects the catalyst downstream NOx, HC, and CO emission amounts by using an NOx sensor value detected by a downstream NOx sensor (the catalyst downstream NOx sensor 29). For example, the correction unit 54 calculates a correction amount of the catalyst downstream NOx, HC, and CO emission amounts based on the catalyst downstream state amount estimated by the second state space model of the catalyst downstream state amount estimation unit 53. At this time, the correction unit 54 calculates a correction parameter that is a difference between the catalyst downstream NOx emission amount and the NOx sensor value detected by the downstream NOx sensor (catalyst downstream NOx sensor 29) based on the corrected catalyst downstream NOx emission amount and the NOx sensor value. Then, the correction unit 54 corrects the estimated catalyst downstream NOx, HC, and CO emission amounts based on the correction parameter.

The correction unit (correction unit 54) corrects the catalyst downstream NOx, HC, and CO emission amounts by using an extended Kalman filter. The correction unit 54 includes an extended Kalman filter that receives input of the catalyst downstream NOx, HC, and CO emission amounts and a signal of the catalyst downstream NOx sensor 29. Then, the ECU 28 realizes OBM by outputting the catalyst downstream NOx, HC, and CO emission amounts which are outputs of the correction unit 54 to a monitoring unit (not illustrated) which is a diagnosis device or the like. The output from the correction unit 54 to the monitoring unit is represented by an arrow extending upward from the correction unit 54. Since the second state space model of the catalyst downstream state amount estimation unit 53 estimates the oxygen storage ratio, the catalyst downstream air-fuel ratio, and the catalyst temperature related to a catalyst deterioration state, catalyst deterioration can be considered, and the catalyst downstream NOx, HC, and CO emission amounts changing in a deteriorated state can be estimated.

A diagnosis unit (NOx sensor diagnosis unit 55) diagnoses the downstream NOx sensor (catalyst downstream NOx sensor 29) based on the catalyst downstream NOx emission amount corrected by the correction unit (correction unit 54) and the NOx sensor value detected by the downstream NOx sensor (catalyst downstream NOx sensor 29). At this time, the diagnosis unit (NOx sensor diagnosis unit 55) diagnoses the downstream NOx sensor (catalyst downstream NOx sensor 29) based on the catalyst downstream NOx emission amount corrected based on the correction parameter calculated by the correction unit 54 and the NOx sensor value detected by the downstream NOx sensor (catalyst downstream NOx sensor 29). For example, the NOx sensor diagnosis unit 55 diagnoses the catalyst downstream NOx sensor 29 by comparing the catalyst downstream NOx emission amount with the NOx sensor value of the catalyst downstream NOx sensor 29. Then, the NOx sensor diagnosis unit 55 outputs a diagnosis result of the catalyst downstream NOx sensor 29. For this reason, degree of deterioration or the like of the catalyst downstream NOx sensor 29 is found early, and it is possible to take measures such as replacement of the catalyst downstream NOx sensor 29.

A fuel injection amount correction unit (fuel injection amount correction unit 56) calculates a correction value of an injection amount of fuel injected by a fuel injection unit based on the catalyst downstream NOx, HC, and CO emission amounts corrected by the correction unit (correction unit 54). For this reason, the fuel injection amount correction unit 56 receives the catalyst downstream NOx, HC, and CO emission amounts as inputs, and calculates a fuel injection amount correction value for reducing the catalyst downstream NOx, HC, and CO emission amounts based on a predetermined fuel injection amount correction map 56a. For example, in a case where the catalyst downstream NOx emission amount increases, the fuel injection amount correction unit 56 outputs a fuel injection amount correction value for shifting a fuel injection amount to the rich side to the fuel injection valve 15. Then, as a result of combustion, an injection amount is adjusted so that the NOx, HC, and CO emission amounts can be reduced to zero or as much as possible. As a result, the fuel injection valve 15 injects fuel whose injection amount is adjusted to have appropriate NOx, HC, and CO emission amounts after combustion. Note that, as an argument of the fuel injection amount correction map 56a, two inputs of the catalyst downstream NOx and HC emission amounts can be set.

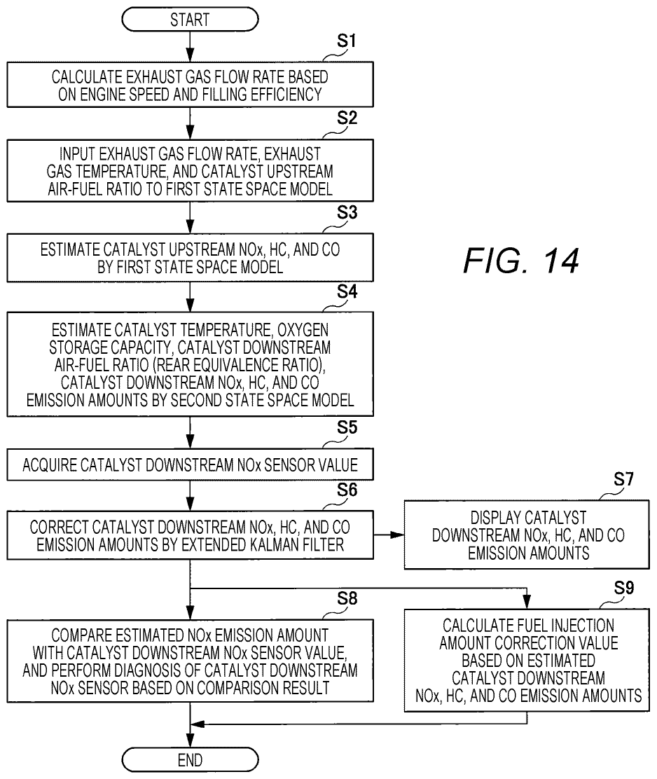

Next, an example of processing of the ECU 28 will be described with reference to FIG. 14.

FIG. 14 is a flowchart illustrating an example of the processing of the ECU 28 according to the present invention.

First, the exhaust gas flow rate calculation unit 51 of the ECU 28 calculates an exhaust gas flow rate by using an engine speed based on the crank angle sensor 18 and filling efficiency based on the flow rate sensor 2 as inputs (S1).

Next, the ECU 28 acquires an exhaust gas flow rate, exhaust gas temperature based on the exhaust gas temperature sensor 26, and a catalyst upstream air-fuel ratio based on the catalyst upstream air-fuel ratio sensor 20 in a storage medium such as a RAM of the ECU 28, and inputs these values to the first state space model of the catalyst upstream state amount estimation unit 52 (S2).

Next, the catalyst upstream state amount estimation unit 52 estimates catalyst upstream state amounts such as catalyst upstream NOx, HC, and CO emission amounts based on the exhaust gas flow rate, the exhaust gas temperature, and the catalyst upstream air-fuel ratio input to the first state space model (S3). As described above, the processing of step S3 includes a first estimation step of inputting an exhaust gas flow rate, exhaust gas temperature, and a catalyst upstream air-fuel ratio to the first machine learning model trained in advance, and estimating the catalyst upstream NOx, HC, and CO emission amounts output by the first machine learning model as the catalyst upstream state amount.

Next, the catalyst downstream state amount estimation unit 53 inputs the exhaust gas flow rate, the exhaust gas temperature, the catalyst upstream air-fuel ratio, and the catalyst upstream NOx, HC, and CO emission amounts to the second state space model. Then, the catalyst downstream state amount estimation unit 53 estimates catalyst downstream state amounts, such as catalyst temperature, oxygen storage capacity, a catalyst downstream air-fuel ratio (rear equivalence ratio), and catalyst downstream NOx, HC, and CO emission amounts based on various types of information input to the second state space model (S4). As described above, the processing of step S4 includes a second estimation step of inputting a catalyst upstream air-fuel ratio, an exhaust gas flow rate, exhaust gas temperature, and a catalyst upstream state amount estimated by the first machine learning model to the second machine learning model trained in advance, and estimating catalyst temperature, oxygen storage capacity, a catalyst downstream air-fuel ratio, and catalyst downstream NOx, HC, and CO emission amounts of the three-way catalyst output by the second machine learning model as a catalyst downstream state amount.

Next, the ECU 28 acquires a sensor value of the catalyst downstream NOx sensor 29 (S5). The sensor value of the catalyst downstream NOx sensor 29 is input to an extended Kalman filter of the correction unit 54 and the NOx sensor diagnosis unit 55.

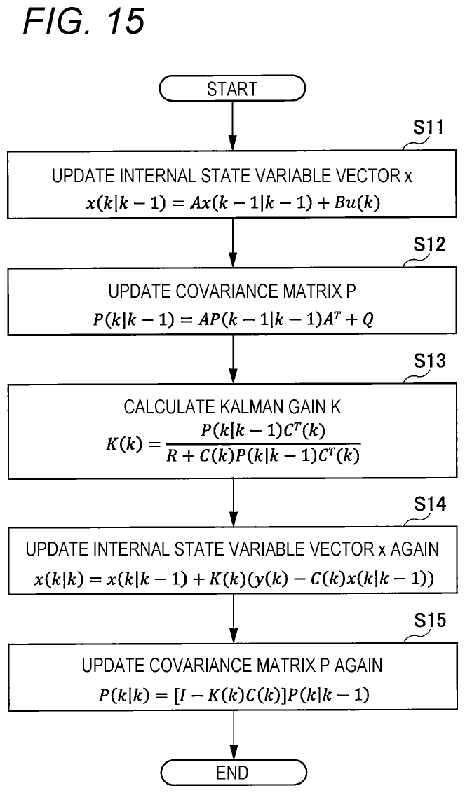

Next, the correction unit 54 inputs the catalyst downstream NOx, HC, and CO emission amounts input from the catalyst downstream state amount estimation unit 53 to the extended Kalman filter, and corrects the catalyst downstream NOx, HC, and CO emission amounts by using the extended Kalman filter (S6). The processing of step S6 embodies processing of calculating, based on the catalyst downstream NOx emission amount corrected by the correction unit 54 and the NOx sensor value detected by the downstream NOx sensor (catalyst downstream NOx sensor 29), a correction parameter that is a difference of the catalyst downstream NOx emission amount. The catalyst downstream NOx, HC, and CO emission amounts obtained in step S6 are used for correction of a fuel injection amount in the subsequent fuel injection amount correction unit 56. Note that the processing performed by the correction unit 54 using the extended Kalman filter is illustrated in FIG. 15 described later.

Next, the correction unit 54 transmits the catalyst downstream NOx, HC, and CO emission amounts corrected in step S6 to a predetermined display unit such as a diagnosis device outside the ECU 28 via a well-known communication means such as controller area network (CAN) communication. For this reason, in the diagnosis device (not illustrated) that receives the catalyst downstream NOx, HC, and CO emission amounts, the catalyst downstream NOx, HC, and CO emission amounts can be indicated (S7), and OBM is realized. As a form of the OBM, for example, display of a time-series graph, display of numerical values, and the like are assumed.

Further, the NOx sensor diagnosis unit 55 compares an estimated value of the catalyst downstream NOx emission amount corrected based on the correction parameter obtained by the correction unit 54 in step S6 with the sensor value acquired from the catalyst downstream NOx sensor 29 in step S5. Then, the NOx sensor diagnosis unit 55 diagnoses the catalyst downstream NOx sensor 29 based on the comparison result (S8). This diagnosis result can also be output to an external diagnosis device (not illustrated) or the like. By this, reliability of values of the catalyst downstream NOx, HC, and CO emission amounts can be enhanced. After step S8, the ECU 28 ends the present processing.

On the other hand, after step S6, in parallel with step S8, the fuel injection amount correction unit 56 calculates a fuel injection amount correction value for reducing the catalyst downstream NOx, HC, and CO emission amounts based on the estimated values (correction values) of the catalyst downstream NOx, HC, and CO emission amounts input from the correction unit 54 (S9). A fuel injection amount of fuel injected from the fuel injection valve 15 is corrected by the fuel injection amount correction value calculated by the fuel injection amount correction unit 56, and fuel is injected from the fuel injection valve 15 with the corrected fuel injection amount. After step S9, the ECU 28 ends the present processing.

FIG. 15 is a flowchart illustrating an example of a Kalman filter algorithm used in the correction unit 54 that corrects the catalyst downstream NOx, HC, and CO emission amounts illustrated in FIG. 13. Here, for the Kalman filter, which is one of constituent elements of the present invention, an algorithm and a method of application to the present control will be described. The Kalman filter is based on a state equation including system noise Q and observation noise R defined by Formulas (1) and (2) below.

[Mathematical formula 1]

x(k|k−1)=Ax(k)+Bu(k)+Q (1)

y(k)=Cx(k)+R (2)

The Kalman filter is divided into a prediction step and a filtering step. In the predicting step, the correction unit 54 updates an internal state variable vector x and a covariance matrix P by Formulas (3) and (4) based on the input variable and the system noise Q (S11,S12).

[Mathematical formula 2]

x(k|k−1)=Ax(k−1|k−1)+Bu(k) (3)

P(k|k−1)=AP(k−1|k−1)A^{T}+Q (4)

Next, in the filtering step, the correction unit 54 calculates a Kalman gain K defined by the updated covariance matrix P and observation noise R by Formula (5) below (S13).

$$\begin{matrix}[ Mathematical formula 3 ] & \\ K ( k ) = \frac{P ( k \vert k - 1 ) {C}^{T} ( k )}{R + C ( k ) P ( k \vert k - 1 ) {C}^{T} ( k )} & ( 5 )\end{matrix}$$

Next, the correction unit 54 updates the internal state variable vector x and the covariance matrix P again by Formulas (6) and (7) below by using a Kalman gain K(k) and observation data (y(k): NOx sensor detection value) (S14 and S15).

[Mathematical formula 4]

x(k|k)=x(k|k−1)+K(k)(y(k)−C(k)x(k|k−1)) (6)

P(k|k)=[I−K(k)C(k)]P(k|k−1) (7)

The term multiplied by the Kalman gain K(k) in Formula (6) represents a difference from a detection value y(k) of the catalyst downstream NOx sensor 29. This difference represents a correction parameter. In this way, the internal state variable vector x and the covariance matrix P are corrected by actual observation data (NOx sensor detection value).

By the above calculation, the correction unit 54 can estimate behavior of an internal state variable x(k|k) that is difficult to directly measure by the catalyst downstream NOx sensor 29 based on measurable output information. For this reason, the correction unit 54 according to the present embodiment estimates the catalyst downstream NOx, HC, and CO emission amounts by the Kalman filter based on a detection value of the catalyst downstream NOx sensor 29.

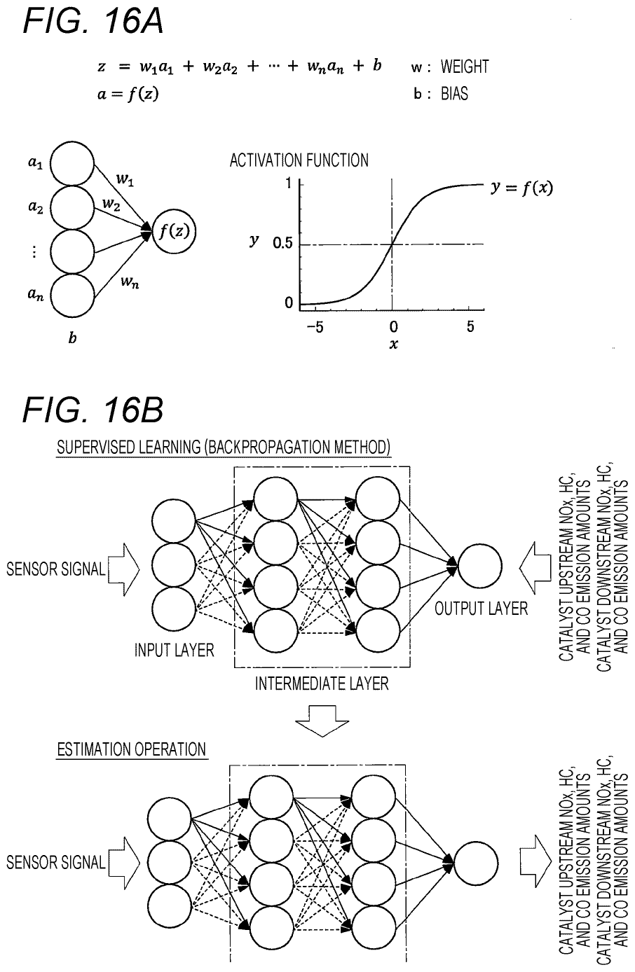

Next, the first machine learning model and the second machine learning model will be described with reference to FIGS. 16A and 16B.

FIG. 16A is a diagram for explaining the first machine learning model constituting the first state space model and the second machine learning model constituting the second state space model.

In the present embodiment, the first machine learning model and the second machine learning model are constituted by a neural network model. The neural network model is a mathematical model imitating a mechanism of a human neural circuit. As illustrated in the upper and lower left of FIG. 16A, a weight w and a bias b are set for each neuron constituting the neural network model. In this neural network model, a function f(z) is obtained as a result of multiplying input signals of a₁ to aₙ by weights w₁ to wₙ, respectively, and further adding the bias b.

Here, a formula z and an input signal a satisfy a relationship below.

z=w₁a₁+w₂a₂+ . . . +wₙaₙ+b

a=f(z)

Further, as illustrated in the lower right of FIG. 16A, a function called an activation function is defined for a neuron. As the activation function, a logistic function, a ramp function, a sigmoid function, and the like are appropriately set. One layer is formed by a plurality of neurons, and an intermediate layer is set between an input layer and an output layer. By increasing the number of neurons and the number of intermediate layers, the neural network model can approximate a more complicated input and output relationship. There is a trade-off relationship between approximation accuracy and a model scale, and a compromise point satisfying requirements of both is selected.

FIG. 16B is a diagram illustrating an example of the neural network model.

An example of the neural network model configured by supervised learning is illustrated on the upper side of FIG. 16B. The neural network model includes an input layer, a plurality of intermediate layers, and an output layer. Then, for example, an exhaust gas sensor signal is set in the input layer, and a result of a catalyst deterioration diagnosis is set in the output layer. Here, a result of the catalyst deterioration diagnosis set in the output layer is, for example, measured catalyst upstream NOx, HC, and CO emission amounts in the case of the first state space model illustrated in FIG. 12. Further, in the case of the second state space model illustrated in FIG. 12, measured catalyst downstream NOx, HC, and CO emission amounts are obtained. After various values are set to the input layer and the output layer, the neural network model can approximate an input and output relationship by changing a weight of each neuron by machine learning (supervised). Note that an error backpropagation method can be applied to an algorithm of this machine learning (supervised).

On the lower side of FIG. 16B, an example of the neural network model used when estimation operation of various values is performed is illustrated. As the neural network model in the estimation operation, a neural network model configured by supervised learning illustrated on the upper side of FIG. 16A is used. Then, an actual sensor signal is input to the input layer of the neural network model, passes through the intermediate layer, and a result of an estimated catalyst deterioration diagnosis is output from the output layer. In the first state space model illustrated in FIG. 12, estimated catalyst upstream NOx, HC, and CO emission amounts are output. Further, in the second state space model illustrated in FIG. 12, estimated catalyst downstream NOx, HC, and CO emission amounts are output.

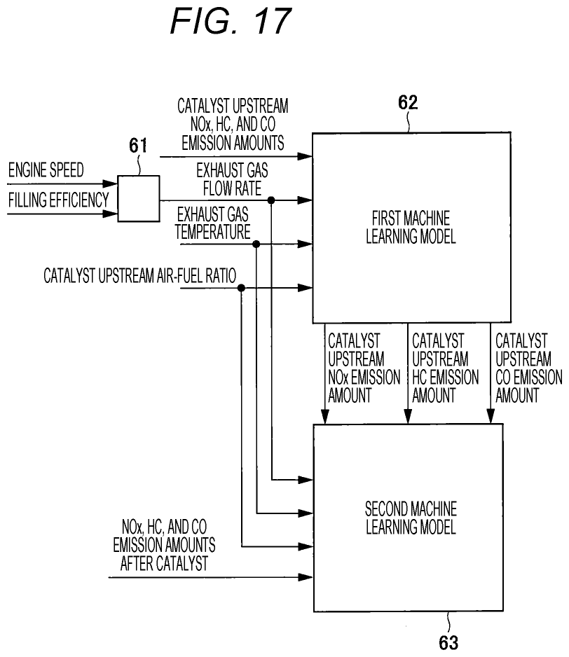

Next, a machine learning step of the first machine learning model and the second machine learning model will be described with reference to FIG. 17.

FIG. 17 is a block diagram of the first and second machine learning models for explaining the machine learning step. Here, the machine learning step (the first learning step and the second learning step) illustrated in FIG. 17 is performed using, for example, a test facility well-known to those skilled in the art such as an engine test room. For this reason, it is possible to execute the machine learning step without actually causing an automobile on which the internal combustion engine 1 to be subjected to the machine learning is mounted to travel on a road.

First, a block 61 calculates an exhaust gas flow rate by using an engine speed based on the crank angle sensor 18 of the internal combustion engine control system 100 and filling efficiency based on the flow rate sensor 2 as inputs. Note that the block 61 may be the same as the exhaust gas flow rate calculation unit 51 illustrated in FIG. 13.

Next, as illustrated on the upper side of FIG. 16B, a block 62 executes machine learning (supervised) of the first machine learning model. For this reason, the block 62 receives input of exhaust gas temperature based on the exhaust gas temperature sensor 26 in the internal combustion engine control system 100, a catalyst upstream air-fuel ratio based on the catalyst upstream air-fuel ratio sensor 20, an exhaust gas flow rate calculated in the block 61, and a catalyst upstream state amount (actual exhaust gas information upstream of the catalyst) obtained by catalyst upstream NOx, HC, and CO sensors additionally provided outside the internal combustion engine control system 100 for the machine learning step (first learning step) of the first machine learning model. Then, catalyst upstream NOx, HC, and CO estimated by the block 62 are output to a block 63 as estimated catalyst upstream state amounts.

Note that, in the present embodiment, exhaust gas temperature and a catalyst upstream air-fuel ratio in machine learning are acquired from the exhaust gas temperature sensor 26 and the catalyst upstream air-fuel ratio sensor 20 provided in the internal combustion engine control system 100. However, the present invention is not limited to this, and exhaust gas temperature and a catalyst upstream air-fuel ratio measured by a measuring device arranged outside the internal combustion engine control system 100 may be input to the block 62.

As illustrated on the upper side of FIG. 16B, the block 63 executes machine learning (supervised) of the second machine learning model. For this reason, the block 63 receives input of the exhaust gas temperature, the catalyst upstream air-fuel ratio, the exhaust gas flow rate, and the information of the catalyst upstream NOx, HC, and CO sensors output from the block 62 described above, and a catalyst downstream state amount (actual exhaust gas information downstream of the catalyst) by catalyst downstream NOx, HC, and CO sensors additionally provided outside the internal combustion engine control system 100 for a preliminary learning step (second learning step) of the second machine learning model.

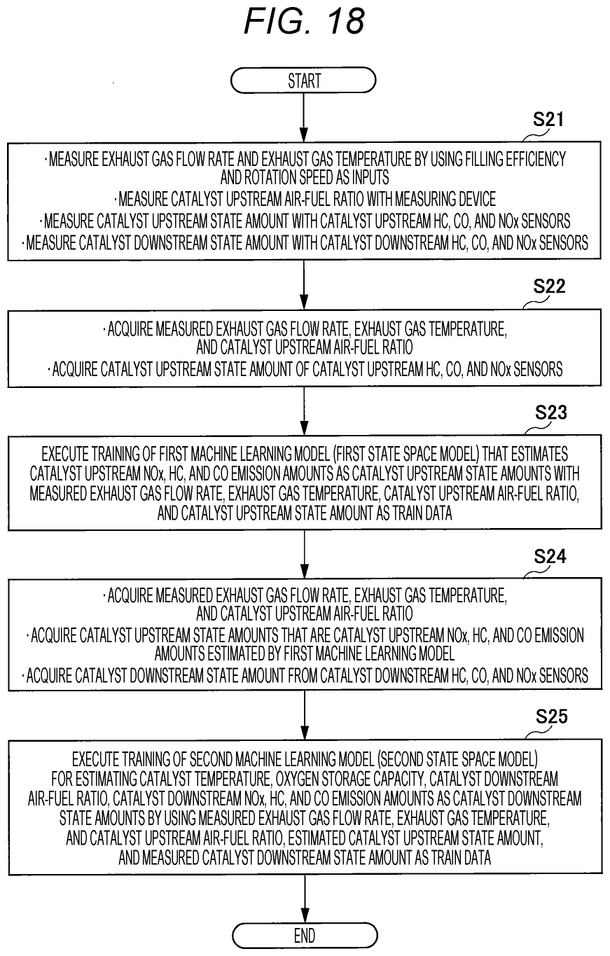

Next, the first learning step and the second learning step will be described with reference to FIG. 18.

FIG. 18 is a flowchart of the first learning step and the second learning step.

First, the block 61 measures an exhaust gas flow rate calculated using an engine speed based on the crank angle sensor 18 of the internal combustion engine control system 100 and filling efficiency based on the flow rate sensor 2 as inputs. Further, exhaust gas temperature is measured by an exhaust gas temperature sensor (not illustrated), and a catalyst upstream air-fuel ratio is measured by a catalyst upstream air-fuel ratio sensor (not illustrated). Further, a catalyst upstream state amount is measured by catalyst upstream HC, CO, and NOx sensors (not illustrated). Further, a catalyst downstream state amount is measured by catalyst downstream HC, CO, and NOx sensors (not illustrated) (S21). These catalyst upstream air-fuel ratio sensor, catalyst upstream HC, CO, NOx sensors, and catalyst downstream HC, CO, NOx sensors (not illustrated) are all provided in a measuring device arranged outside the internal combustion engine control system 100.

Next, the block 62 acquires a measured exhaust gas flow rate from the block 61. Further, the block 62 acquires measured exhaust gas temperature and catalyst upstream air-fuel ratio. Further, the block 62 acquires a catalyst upstream state amount which is a sensor value obtained from the catalyst upstream NOx, HC, and CO sensors (S22).

Next, the block 62 receives input of the measured exhaust gas flow rate, exhaust gas temperature, and catalyst upstream air-fuel ratio, and the measured catalyst upstream state amount as train data to execute learning of the first machine learning model (first state space model) (first learning step). Here, the block 62 executes learning of the first machine learning model (first state space model) for estimating catalyst upstream NOx, HC, and CO emission amounts as catalyst upstream state amounts based on the input train data (S23).

The first machine learning model (first state space model) approximates a complex input and output relationship of values of a catalyst upstream air-fuel ratio, an exhaust gas flow rate, and exhaust gas temperature on the input side of the neural network model, and a catalyst upstream state amount outside the internal combustion engine control system 100 on the output side of the neural network model.

Next, the block 63 acquires the measured exhaust gas flow rate, exhaust gas temperature, and catalyst upstream air-fuel ratio described above, and acquires catalyst upstream state amounts which are catalyst upstream NOx, HC, and CO emission amounts estimated by the first machine learning model. Furthermore, the block 63 acquires catalyst downstream state amounts measured by the catalyst downstream HC, CO, and NOx sensors from catalyst downstream HC, CO, and NOx (S24).

Next, the block 63 receives input of the measured exhaust gas flow rate, exhaust gas temperature, and catalyst upstream air-fuel ratio, the catalyst upstream state amount estimated by the first machine learning model, and the measured catalyst downstream state amounts (Catalyst downstream NOx, HC, and CO emission amounts) as train data to execute learning of the second machine learning model (second state space model) (second learning step). Here, the block 63 executes learning of the second machine learning model (second state space model) for estimating catalyst temperature, oxygen storage capacity, a catalyst downstream air-fuel ratio, and catalyst downstream NOx, HC, and CO emission amounts of a three-way catalyst as catalyst downstream state amounts (S25).

The second machine learning model (second state space model) approximates a complex input and output relationship of values of the exhaust gas flow rate, the exhaust gas temperature, the catalyst upstream air-fuel ratio, and the catalyst upstream state amount on the input side of the neural network model, and the catalyst downstream state amount outside the internal combustion engine control system 100 on the output side of the neural network model.

Note that the first learning step and the second learning step can be executed using a general-purpose computer provided separately from the ECU 28.

In the ECU 28 according to the first embodiment described above, a catalyst downstream NOx emission amount, a catalyst downstream HC emission amount, and a catalyst downstream CO emission amount are estimated based on information obtained from an existing sensor or the like installed in the internal combustion engine 1. For this reason, it is possible to indicate a catalyst downstream NOx emission amount, a catalyst downstream HC emission amount, and a catalyst downstream CO emission amount in real time without providing expensive HC and CO sensors upstream of the catalyst.

Here, the catalyst upstream state amount estimation unit 52 of the ECU 28 can estimate catalyst upstream NOx, HC, and CO emission amounts as catalyst upstream state amounts by inputting a catalyst upstream air-fuel ratio, an exhaust gas flow rate, and exhaust gas temperature to the first machine learning model. In the first machine learning model, learning is executed in advance using measured catalyst upstream air-fuel ratio, exhaust gas flow rate, exhaust gas temperature, and the like, and a measured catalyst upstream state amount as train data, and it is possible to easily estimate catalyst upstream NOx, HC, and CO emission amounts from various values input in a complex manner.

Further, the catalyst downstream state amount estimation unit 53 of the ECU 28 can estimate catalyst downstream NOx, HC, and CO emission amounts, an oxygen storage ratio, a catalyst downstream air-fuel ratio, and catalyst temperature as catalyst downstream state amounts by inputting a catalyst upstream air-fuel ratio, an exhaust gas flow rate, and exhaust gas temperature, and a catalyst upstream state amount estimated by the catalyst upstream state amount estimation unit 52 to the second machine learning model. In the second machine learning model, learning is executed in advance using measured exhaust gas flow rate, exhaust gas temperature, and catalyst upstream air-fuel ratio, a catalyst upstream state amount estimated by the first machine learning model, and measured catalyst downstream state amounts (catalyst downstream NOx, HC, and CO emission amounts) as train data. Then, the second machine learning model can easily estimate catalyst downstream NOx, HC, CO emission amounts, an oxygen storage ratio, a catalyst downstream air-fuel ratio, and catalyst temperature from various values input in a complex manner.

Further, the correction unit 54 of the ECU 28 can correct catalyst downstream state amounts (catalyst downstream NOx, HC, and CO emission amounts) estimated by the catalyst downstream state amount estimation unit 53 by using an extended Kalman filter. Then, the corrected catalyst downstream state amounts (catalyst downstream NOx, HC, and CO emission amounts) are displayed on the monitoring unit in real time.

Further, the NOx sensor diagnosis unit 55 of the ECU 28 can diagnose the catalyst downstream NOx sensor 29 by comparing a catalyst downstream NOx value corrected by the correction unit 54 with a sensor value of the catalyst downstream NOx sensor 29. For this reason, occurrence of abnormality of the catalyst downstream NOx sensor 29 can be obtained at an early stage, and the catalyst downstream NOx sensor 29 can be replaced at an early stage. Further, when the ECU 28 detects that the catalyst downstream NOx sensor 29 deteriorates according to a diagnosis result, a sensor value of the catalyst downstream NOx sensor 29 is not used for control, and a catalyst downstream NOx value corrected by the correction unit 54 can be used for control.

Further, the fuel injection amount correction unit 56 of the ECU 28 corrects a fuel injection amount based on catalyst downstream state amounts (catalyst downstream NOx, HC, and CO emission amounts) corrected by the correction unit 54. For this reason, the ECU 28 can perform control to maintain an equivalence ratio at a stoichiometric air-fuel ratio, which is the triple point, and to maintain a purification rate of the three-way catalyst at a high level.

### Second Embodiment

In the first embodiment described above, for example, the internal combustion engine 1 that mainly burns gasoline is described, but the present invention is not limited to this. For example, the present invention can also be applied to the internal combustion engine 1 that burns gasoline alternative fuel such as synthetic fuel derived from hydrogen or what is called biofuel based on a natural material derived from animals and plants.

A second embodiment of the present invention is configured to switch learning data of the input and output relationship used in the first state space model and the second state space model according to a fuel type in order to cope with a case where a fuel composition, such as synthetic fuel derived from hydrogen or biofuel, changes. By this, the ECU can estimate NOx, HC, and CO emission amounts downstream of the catalyst according to various types of fuel.

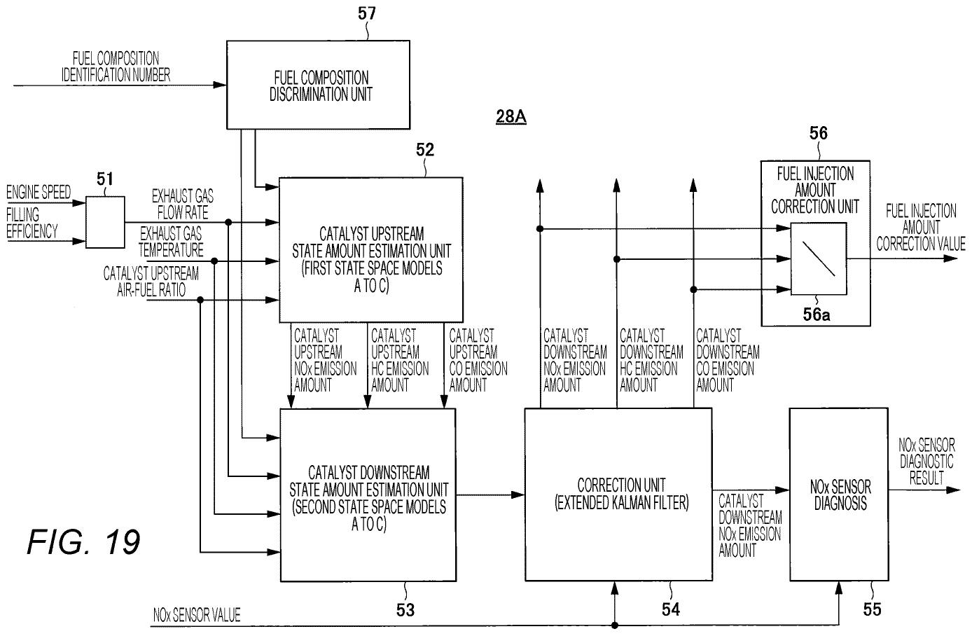

FIG. 19 is a block diagram illustrating an internal configuration example of an ECU 28A according to the second embodiment. The ECU 28 includes blocks 51 to 56 below.

The exhaust gas flow rate calculation unit 51 calculates an exhaust gas flow rate by using an engine speed based on the crank angle sensor 18 and filling efficiency based on the flow rate sensor 2 as inputs.

The catalyst upstream state amount estimation unit 52 uses exhaust gas temperature based on the exhaust gas temperature sensor 26, a catalyst upstream air-fuel ratio based on the catalyst upstream air-fuel ratio sensor 20, and an exhaust gas flow rate as inputs, and configures the first state space model that estimates the catalyst upstream NOx, HC, and CO emission amounts. The first state space model includes a plurality of pieces of learning data corresponding to the various types of fuel described above. For example, a first machine learning model A for which the first learning step is executed in a state where synthetic fuel derived from hydrogen is burned in the internal combustion engine 1, a first machine learning model B for which the first learning step is executed in a state where biofuel is burned in the internal combustion engine 1, and a first machine learning model C for which the first learning step is executed in a state where standard gasoline is burned are switchable.

The catalyst downstream state amount estimation unit 53 is the second state space model that receives exhaust gas temperature, a catalyst upstream air-fuel ratio, catalyst upstream NOx, HC, and CO emission amounts as inputs, and estimates catalyst downstream NOx, HC, and CO emission amounts, an oxygen storage ratio, a catalyst downstream air-fuel ratio, and catalyst temperature. The second state space model includes a plurality of pieces of learning data corresponding to the various types of fuel described above. For example, a second machine learning model A for which the second learning step is executed in a state where synthetic fuel derived from hydrogen is burned in the internal combustion engine 1, a second machine learning model B for which the second learning step is executed in a state where biofuel is burned in the internal combustion engine 1, and a second machine learning model C for which the second learning step is executed in a state where standard gasoline is burned are switchable.

A fuel composition discrimination unit (fuel composition discrimination unit 57) discriminates a composition of fuel. For example, the fuel composition discrimination unit 57 includes a receiving unit (not illustrated) that receives a fuel composition identification number assigned in advance to fuel such as gasoline, synthetic fuel derived from hydrogen, or biofuel. The fuel composition discrimination unit 57 switches the first machine learning models A to C or the second machine learning models A to C based on a fuel composition identification number received by the receiving unit (not illustrated) included in the ECU 28. As described above, the fuel composition discrimination unit 57 can set the first state space model and the second state space model so as to be suitable for the set fuel.

For this reason, the catalyst upstream state amount estimation unit (catalyst upstream state amount estimation unit 52) includes a plurality of types of the first machine learning models trained in advance according to a fuel composition, and selects one of a plurality of types of the first machine learning models based on a fuel composition discriminated by the fuel composition discrimination unit (fuel composition discrimination unit 57). For this reason, the catalyst upstream state amount estimation unit 52 can estimate catalyst upstream NOx, HC, and CO emission amounts as catalyst upstream state amounts by the first machine learning model selected according to fuel burned in the internal combustion engine 1.

Further, the catalyst downstream state amount estimation unit (catalyst downstream state amount estimation unit 53) includes a plurality of types of the second machine learning models trained in advance according to a fuel composition, and selects one of a plurality of types of the second machine learning models based on a fuel composition discriminated by the fuel composition discrimination unit (fuel composition discrimination unit 57). For this reason, the catalyst downstream state amount estimation unit 53 can estimate catalyst temperature, oxygen storage capacity, a catalyst downstream air-fuel ratio, and catalyst downstream NOx, HC, and CO emission amounts of the three-way catalyst as catalyst downstream state amounts by the second machine learning model selected according to fuel burned in the internal combustion engine 1.

The correction unit 54 is an example of a correction unit that derives catalyst downstream NOx, HC, and CO emission amounts based on the catalyst downstream NOx, HC, and CO emission amounts estimated by the second state space model. The correction unit 54 includes an extended Kalman filter that receives input of the catalyst downstream NOx, HC, and CO emission amounts and a signal of the catalyst downstream NOx sensor 29.

The NOx sensor diagnosis unit 55 compares the catalyst downstream NOx emission amount with the sensor value of the catalyst downstream NOx sensor 29, diagnoses the catalyst downstream NOx sensor 29, and outputs a diagnosis result.

The fuel injection amount correction unit 56 receives the catalyst downstream NOx, HC, and CO emission amounts as inputs, and calculates a fuel injection amount correction value for reducing the catalyst downstream NOx, HC, and CO emission amounts based on the predetermined fuel injection amount correction map 56a. For example, in a case where the catalyst downstream NOx emission amount increases, the fuel injection amount correction unit 56 outputs a fuel injection amount correction value for shifting a fuel injection amount to the rich side to the fuel injection valve 15. Here, as an argument of the fuel injection amount correction map 56a, two inputs of catalyst downstream NOx and HC emission amounts can be set.

Then, the ECU 28A outputs catalyst downstream NOx, HC, and CO, which are outputs of the correction unit 54, to a monitoring unit (not illustrated) such as a diagnosis device, so as to realize OBM corresponding to various types of gasoline alternative fuel.

Next, processing performed by the ECU 28A according to the second embodiment will be described.

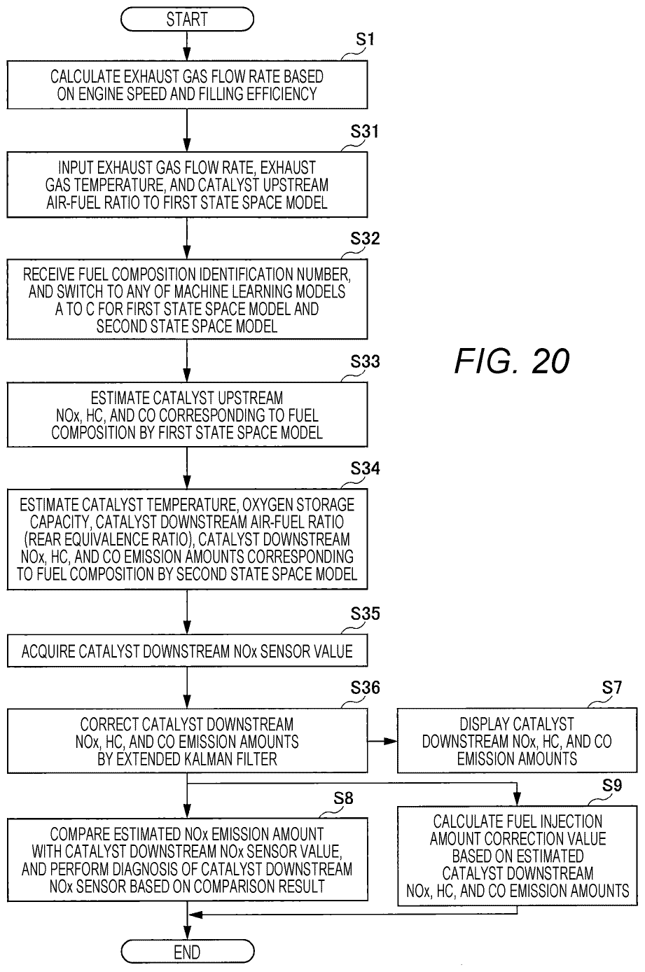

FIG. 20 is a flowchart illustrating an example of processing of the ECU 28A.

First, the exhaust gas flow rate calculation unit 51 of the ECU 28A calculates an exhaust gas flow rate by using an engine speed based on the crank angle sensor 18 and filling efficiency based on the flow rate sensor 2 as inputs (S1).

Next, the ECU 28A acquires an exhaust gas flow rate, exhaust gas temperature based on the exhaust gas temperature sensor 26, and a catalyst upstream air-fuel ratio based on the catalyst upstream air-fuel ratio sensor 20 in a storage medium such as a RAM of the ECU 28A, and inputs these values to the first state space model of the catalyst upstream state amount estimation unit 52 (S31).

Next, the fuel composition discrimination unit 57 receives a fuel composition identification number. Then, the fuel composition discrimination unit 57 performs switching and setting to any of the first machine learning models A to C with respect to the first state space model of the catalyst upstream state amount estimation unit 52 based on the received fuel composition identification number. In addition, the fuel composition discrimination unit 57 performs switching and setting to any of the second machine learning models A to C with respect to the second state space model of the catalyst downstream state amount estimation unit 53 based on the received fuel composition identification number (S32).

Next, the catalyst upstream state amount estimation unit 52 inputs an exhaust gas flow rate, exhaust gas temperature, and a catalyst upstream air-fuel ratio to the first state space model to which the first machine learning model is switched and set in step S32, and estimates catalyst upstream NOx, HC, and CO emission amounts corresponding to a fuel composition (S33).

Next, the catalyst downstream state amount estimation unit 53 inputs an exhaust gas flow rate, exhaust gas temperature, a catalyst upstream air-fuel ratio, and catalyst upstream NOx, HC, and CO emission amounts to the second state space model to which the second machine learning model is switched and set in step S32. Then, the catalyst downstream state amount estimation unit 53 estimates catalyst downstream state amounts such as catalyst temperature, oxygen storage capacity (OSC), a catalyst downstream air-fuel ratio (rear equivalence ratio), and catalyst downstream NOx, HC, and CO emission amounts corresponding to a fuel composition (S34).

Next, the ECU 28 acquires a sensor value of the catalyst downstream NOx sensor 29 (S35). The sensor value of the catalyst downstream NOx sensor 29 is input to an extended Kalman filter of the correction unit 54 and the NOx sensor diagnosis unit 55.

Next, the correction unit 54 obtains catalyst downstream NOx, HC, and CO emission amounts based on the catalyst downstream NOx, HC, and CO emission amounts by using the extended Kalman filter (S36).

Since the processing of steps S7 to S9 after step S36 is the same as the processing of each step in the ECU 28 according to the first embodiment described with reference to FIG. 14, detailed description of the processing will be omitted.

Since the ECU 28A according to the second embodiment described above includes the fuel composition discrimination unit 57, the catalyst upstream state amount estimation unit 52 can select an optimum first machine learning model according to a discrimination result of a fuel composition. Similarly, the catalyst downstream state amount estimation unit 53 can select an optimum second machine learning model according to a discrimination result of a fuel composition by the fuel composition discrimination unit 57. For this reason, all of catalyst upstream NOx, HC, and CO emission amounts estimated by the first machine learning model and catalyst downstream NOx, HC, and CO emission amounts estimated by the second machine learning model are estimated as appropriate values.

Note that the present invention is not limited to the above-described embodiments, and it is obvious that various other application examples and variations can be taken without departing from the gist of the present invention described in the claims.

For example, the above-described embodiments describe a configuration of the system in detail and specifically in order to describe the present invention in an easy-to-understand manner, and are not necessarily limited to those having all the described configurations. Further, it is also possible to add, delete, and replace other configurations to and with a part of the configurations of the present embodiment.

Further, control lines and information lines indicate what is considered to be necessary for explanation, and do not necessarily indicate all control lines and information lines on a product. In practice, it may be considered that almost all configurations are connected to each other.

### REFERENCE SIGNS LIST

1 internal combustion engine
20 catalyst upstream air-fuel ratio sensor
21 exhaust purification catalyst
22 rear oxygen sensor
28 ECU
51 exhaust gas flow rate calculation unit
52 catalyst upstream state amount estimation unit
53 catalyst downstream state amount estimation unit
54 correction unit
55 NOx sensor diagnosis unit
56 fuel injection amount correction unit
56a fuel injection amount correction map
57 fuel composition discrimination unit
100 internal combustion engine control system
110 aftertreatment system

1. An internal combustion engine control device that controls an internal combustion engine including an upstream air-fuel ratio sensor that is provided in an exhaust pipe, arranged upstream of a three-way catalyst having oxygen storage capacity, and detects a catalyst upstream air-fuel ratio of exhaust gas, and a downstream NOx sensor that is arranged downstream of the three-way catalyst and detects NOx downstream of the three-way catalyst, the internal combustion engine control device comprising:
an exhaust gas flow rate calculation unit that calculates an exhaust gas flow rate of the exhaust gas;
a catalyst upstream state amount estimation unit that estimates a catalyst upstream NOx emission amount, a catalyst upstream HC emission amount, and a catalyst upstream CO emission amount as a catalyst upstream state amount, with the catalyst upstream air-fuel ratio, the exhaust gas flow rate, and exhaust gas temperature detected by an exhaust gas temperature sensor as inputs;
a catalyst downstream state amount estimation unit that estimates catalyst temperature, the oxygen storage capacity, a catalyst downstream air-fuel ratio, a catalyst downstream NOx emission amount, a catalyst downstream HC emission amount, and a catalyst downstream CO emission amount of the three-way catalyst as a catalyst downstream state amount, with the catalyst upstream air-fuel ratio, the exhaust gas flow rate, the exhaust gas temperature, and the catalyst upstream state amount as inputs; and
a correction unit that corrects the catalyst downstream NOx emission amount, the catalyst downstream HC emission amount, and the catalyst downstream CO emission amount by using an NOx sensor value detected by the downstream NOx sensor.

2. The internal combustion engine control device according to claim 1, wherein
the catalyst upstream state amount estimation unit inputs the catalyst upstream air-fuel ratio, the exhaust gas flow rate, and the exhaust gas temperature to a first machine learning model trained in advance, and estimates the catalyst upstream NOx emission amount, the catalyst upstream HC emission amount, and the catalyst upstream CO emission amount output by the first machine learning model as the catalyst upstream state amount.

3. The internal combustion engine control device according to claim 2, wherein
the catalyst downstream state amount estimation unit inputs the catalyst upstream air-fuel ratio, the exhaust gas flow rate, the exhaust gas temperature, and the catalyst upstream state amount to a second machine learning model trained in advance, and estimates the catalyst temperature, the oxygen storage capacity, the catalyst downstream air-fuel ratio, and the catalyst downstream NOx emission amount, the catalyst downstream HC emission amount, and the catalyst downstream CO emission amount output by the second machine learning model as the catalyst downstream state amount.

4. The internal combustion engine control device according to claim 3, wherein
the correction unit corrects the catalyst downstream NOx emission amount, the catalyst downstream HC emission amount, and the catalyst downstream CO emission amount by using an extended Kalman filter.

5. The internal combustion engine control device according to claim 3, further comprising a fuel injection amount correction unit that calculates a correction value of an injection amount of fuel injected by a fuel injection unit based on the catalyst downstream NOx emission amount, the catalyst downstream HC emission amount, and the catalyst downstream CO emission amount corrected by the correction unit.

6. The internal combustion engine control device according to claim 3, further comprising a diagnosis unit that diagnoses the NOx sensor based on the catalyst downstream NOx emission amount corrected by the correction unit and an NOx sensor value detected by the downstream NOx sensor.

7. The internal combustion engine control device according to claim 3, further comprising a fuel composition discrimination unit that discriminates a composition of fuel, wherein
the catalyst upstream state amount estimation unit includes a plurality of types of first machine learning models trained in advance according to a composition of fuel, and selects one of the first machine learning models from a plurality of types of the first machine learning models based on a composition of fuel discriminated by the fuel composition discrimination unit, and
the catalyst downstream state amount estimation unit includes a plurality of types of second machine learning models trained in advance according to a composition of fuel, and selects one of the second machine learning models from a plurality of types of the second machine learning models based on a composition of fuel discriminated by the fuel composition discrimination unit.

8. A state amount estimation method of estimating a state amount of an internal combustion engine including an upstream air-fuel ratio sensor that is provided in an exhaust pipe, arranged upstream of a three-way catalyst having oxygen storage capacity, and detects a catalyst upstream air-fuel ratio of exhaust gas, and a downstream NOx sensor that is arranged downstream of the three-way catalyst and detects NOx downstream of the three-way catalyst, the state amount estimation method comprising steps of:
calculating an exhaust gas flow rate of the exhaust gas;
estimating a catalyst upstream NOx emission amount, a catalyst upstream HC emission amount, and a catalyst upstream CO emission amount as a catalyst upstream state amount, with the catalyst upstream air-fuel ratio, the exhaust gas flow rate, and exhaust gas temperature detected by an exhaust gas temperature sensor as inputs;
estimating catalyst temperature, the oxygen storage capacity, a catalyst downstream air-fuel ratio, a catalyst downstream NOx emission amount, a catalyst downstream HC emission amount, and a catalyst downstream CO emission amount of the three-way catalyst as a catalyst downstream state amount, with the catalyst upstream air-fuel ratio, the exhaust gas flow rate, the exhaust gas temperature, and the catalyst upstream state amount as inputs; and
correcting, by using an NOx sensor value detected by the downstream NOx sensor, the catalyst downstream NOx emission amount, the catalyst downstream HC emission amount, and the catalyst downstream CO emission amount that are estimated.

9. The state amount estimation method according to claim 8, further comprising:
a step of measuring the catalyst upstream air-fuel ratio, the exhaust gas flow rate upstream of the three-way catalyst, and the exhaust gas temperature; and
a first learning step of causing a first machine learning model to perform learning, the first machine learning model estimating the catalyst upstream NOx emission amount, the catalyst upstream HC emission amount, and the catalyst upstream CO emission amount as the catalyst upstream state amount by receiving, as train data, input of the exhaust gas flow rate, the exhaust gas temperature, and the catalyst upstream air-fuel ratio that are measured, and the catalyst upstream NOx emission amount, the catalyst upstream HC emission amount, and the catalyst upstream CO emission amount that are measured.

10. The state amount estimation method according to claim 9, further comprising:
a step of measuring the catalyst downstream NOx emission amount, the catalyst downstream HC emission amount, and the catalyst downstream CO emission amount; and
a second learning step of causing a second machine learning model to perform learning, the second machine learning model estimating catalyst temperature, the oxygen storage capacity, the catalyst downstream air-fuel ratio, and the catalyst downstream NOx emission amount, the catalyst downstream HC emission amount, and the catalyst downstream CO emission amount of the three-way catalyst as the catalyst downstream state amount by receiving, as train data, input of the exhaust gas flow rate, the exhaust gas temperature, and the catalyst upstream air-fuel ratio that are measured, the catalyst upstream state amount estimated by the first machine learning model, and the catalyst downstream NOx emission amount, catalyst downstream HC emission amount, and catalyst downstream CO emission amount that are measured.

11. The state amount estimation method according to claim 10, further comprising a first estimation step of inputting the catalyst upstream air-fuel ratio, the exhaust gas flow rate, and the exhaust gas temperature to the first machine learning model trained in advance, and estimating the catalyst upstream NOx emission amount, the catalyst upstream HC emission amount, and the catalyst upstream CO emission amount output by the first machine learning model as the catalyst upstream state amount.

12. The state amount estimation method according to claim 11, further comprising a second estimation step of inputting the catalyst upstream air-fuel ratio, the exhaust gas flow rate, the exhaust gas temperature, and the catalyst upstream state amount estimated by the first machine learning model to the second machine learning model trained in advance, and estimating catalyst temperature, the oxygen storage capacity, the catalyst downstream air-fuel ratio, and the catalyst downstream NOx emission amount, the catalyst downstream HC emission amount, and the catalyst downstream CO emission amount of the three-way catalyst output by the second machine learning model as the catalyst downstream state amount.

13. The state amount estimation method according to claim 12, further comprising a step of calculating, based on the catalyst downstream NOx emission amount that is corrected and an NOx sensor value detected by the downstream NOx sensor, a correction parameter that is a difference between the catalyst downstream NOx emission amount and the NOx sensor value, wherein
the catalyst downstream NOx emission amount, the catalyst downstream HC emission amount, and the catalyst downstream CO emission amount that are estimated are corrected based on the correction parameter.

14. The state amount estimation method according to claim 13, further comprising a step of diagnosing the NOx sensor based on the catalyst downstream NOx emission amount corrected based on the correction parameter and an NOx sensor value detected by the downstream NOx sensor.
